(19) United States
(12) Patent Application Publication
(10) Pub. No.: US 2026/0301301 A1
(43) Pub. Date: Oct. 1, 2026

(54) SETUP TIME IMPROVEMENT FOR GENERATION OF VIRTUAL REPRESENTATIONS OF USERS

(71) Applicant: QUALCOMM Incorporated, San Diego, CA (US)

(72) Inventors: Nikolai Konrad LEUNG, San Francisco, CA (US); Thomas STOCKHAMMER, Bergen (DE); Imed BOUAZIZI, Celina, TX (US); Liangping MA, San Diego, CA (US)

(21) Appl. No.: 19/561,390

(22) Filed: Mar. 9, 2026

Related U.S. Application Data
(60) Provisional application No. 63/777,642, filed on Mar. 25, 2025.

(51) Int. Cl. G06T 15/00; G06T 13/40

(52) U.S. Cl. CPC G06T 15/005; G06T 13/40; G06T 2210/36

(57) ABSTRACT

Systems and techniques are described for generating virtual content. For example, a first device can begin downloading avatar information for a virtual representation of a user of a second device for a virtual session. The first device can receive, from a network device associated with the virtual session, a first rendering of the virtual representation of the user of the second device while downloading the avatar information for the virtual representation of the user of the second device. The first device can render a virtual scene including the first rendering of the virtual representation of the user of the second device. Upon downloading of the avatar information, the first device can generate a second rendering of the virtual representation of the user of the second device using the downloaded avatar information. The first device can render the virtual scene including the second rendering of the virtual representation of the user.

### CROSS REFERENCE TO RELATED PATENT APPLICATION

This application claims priority to U.S. Provisional Patent Application Ser. No. 63/777,642 titled “SETUP TIME IMPROVEMENT FOR GENERATION OF VIRTUAL REPRESENTATIONS OF USERS,” filed on Mar. 25, 2025, which is incorporated herein by reference in its entirety for all purposes.

### TECHNICAL FIELD

The present disclosure generally relates to virtual content for virtual environments or partially virtual environments. For example, aspects of the present disclosure include systems and techniques for providing distributed generation of virtual content, which can provide setup time improvement for generation of virtual representations (e.g., avatars), such as for conference sessions.

### BACKGROUND

An extended reality (XR) (e.g., virtual reality, augmented reality, mixed reality) system can provide a user with a virtual experience by immersing the user in a completely virtual environment (made up of virtual content) and/or can provide the user with an augmented or mixed reality experience by combining a real-world or physical environment with a virtual environment.

One example use case for XR content that provides virtual, augmented, or mixed reality to users is to present a user with a “metaverse” experience. The metaverse is essentially a virtual universe that includes one or more three-dimensional (3D) virtual worlds. For example, a metaverse virtual environment may allow a user to virtually interact with other users (e.g., in a social setting, in a virtual meeting, etc.), to virtually shop for goods, services, property, or other item, to play computer games, and/or to experience other services.

In some cases, a user may be represented in a virtual environment (e.g., a metaverse virtual environment) as a virtual representation of the user, sometimes referred to as an avatar. In any virtual environment, it is important for a system to be able to set up a call for a virtual representation with high-quality avatars representing a person in an efficient manner.

### SUMMARY

Systems and techniques are described for providing a distributed generation of virtual content for a virtual environment (e.g., a metaverse virtual environment). In some aspects, an apparatus for generating virtual content at a first device in a distributed system is provided. The apparatus includes at least one memory and at least one processor coupled to the at least one memory and configured to: begin downloading, from a repository, avatar information for a virtual representation of a user of a second device for a virtual session; receive, from a network device associated with the virtual session, a first rendering of the virtual representation of the user of the second device while downloading the avatar information for the virtual representation of the user of the second device; render a virtual scene including the first rendering of the virtual representation of the user of the second device; upon download of the avatar information for the virtual representation of the user of the second device, generate a second rendering of the virtual representation of the user of the second device using the downloaded avatar information; and render the virtual scene including the second rendering of the virtual representation of the user of the second device.

In some aspects, a method is provided for generating virtual content at a first device in a distributed system is provided. The method includes: begin downloading, from a repository, avatar information for a virtual representation of a user of a second device for a virtual session; receiving, from a network device associated with the virtual session, a first rendering of the virtual representation of the user of the second device while downloading the avatar information for the virtual representation of the user of the second device; rendering a virtual scene including the first rendering of the virtual representation of the user of the second device; upon downloading of the avatar information for the virtual representation of the user of the second device, generating a second rendering of the virtual representation of the user of the second device using the downloaded avatar information; and rendering the virtual scene including the second rendering of the virtual representation of the user of the second device.

In another example, at least one non-transitory computer-readable medium (CRM) is provided that has stored thereon machine-executable instructions that, when executed by at least one processor of a computing device, cause the computing device to: begin downloading, from a repository, avatar information for a virtual representation of a user of a second device for a virtual session; receive, from a network device associated with the virtual session, a first rendering of the virtual representation of the user of the second device while downloading the avatar information for the virtual representation of the user of the second device; render a virtual scene including the first rendering of the virtual representation of the user of the second device; upon download of the avatar information for the virtual representation of the user of the second device, generate a second rendering of the virtual representation of the user of the second device using the downloaded avatar information; and render the virtual scene including the second rendering of the virtual representation of the user of the second device.

In another example, an apparatus for generating virtual content at a first device in a distributed system is provided. The apparatus includes: means for beginning downloading, from a repository, avatar information for a virtual representation of a user of a second device for a virtual session; means for receiving, from a network device associated with the virtual session, a first rendering of the virtual representation of the user of the second device while downloading the avatar information for the virtual representation of the user of the second device; means for rendering a virtual scene including the first rendering of the virtual representation of the user of the second device; means for, upon downloading of the avatar information for the virtual representation of the user of the second device, generating a second rendering of the virtual representation of the user of the second device using the downloaded avatar information; and means for rendering the virtual scene including the second rendering of the virtual representation of the user of the second device.

In some aspects, one or more of the apparatuses described herein is, is part of, and/or includes an extended reality (XR) device or system (e.g., a virtual reality (VR) device, an augmented reality (AR) device, or a mixed reality (MR) device), a mobile device (e.g., a mobile telephone or other mobile device), a wearable device, a wireless communication device, a camera, a personal computer, a laptop computer, a vehicle or a computing device or component of a vehicle, a server computer or server device (e.g., an edge or cloud-based server, a personal computer acting as a server device, a mobile device such as a mobile phone acting as a server device, an XR device acting as a server device, a vehicle acting as a server device, a network router, or other device acting as a server device), another device, or a combination thereof. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyroscopes, one or more gyrometers, one or more accelerometers, any combination thereof, and/or other sensor.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a diagram illustrating an example of an extended reality (XR) system, according to aspects of the disclosure;

FIG. 2 is a diagram illustrating an example of a three-dimensional (3D) collaborative virtual environment, according to aspects of the disclosure;

FIG. 3 is a diagram illustrating an example of an XR system in which two client devices exchange information used to generate virtual representations of users and to compose a virtual scene, according to aspects of the disclosure;

FIG. 4 is a diagram illustrating another example of an XR system, according to aspects of the disclosure;

FIG. 5 is a diagram illustrating an example configuration of a client device, according to aspects of the disclosure;

FIG. 6 is a diagram illustrating an example of an XR system including an animation and scene rendering system in communication with client devices, according to aspects of the disclosure;

FIG. 7 is a diagram illustrating another example of an XR system including an animation and scene rendering system in communication with client devices, according to aspects of the disclosure;

FIG. 8 is a diagram illustrating an illustrative example of a user virtual representation system of an animation and scene rendering system, according to aspects of the disclosure;

FIG. 9 is a diagram illustrating an illustrative example of a scene composition system of an animation and scene rendering system, according to aspects of the disclosure;

FIG. 10 is a diagram illustrating another example of an XR system including an animation and scene rendering system in communication with client devices, according to aspects of the disclosure;

FIG. 11 is a diagram illustrating another example of an XR system including an animation and scene rendering system in communication with client devices, according to aspects of the disclosure;

FIG. 12 is an example of avatar representation format, according to aspects of the disclosure;

FIG. 13 is a diagram illustrating an example of a mesh of a user, an example of a normal map of the user, an example of an albedo map of the user, an example of a specular reflection map of the user, and an example of personalized for the user, according to aspects of the disclosure;

FIG. 14A is a diagram illustrating an example of a raw (non-retopologized) mesh, according to aspects of the disclosure;

FIG. 14B is a diagram illustrating an example of a retopologized mesh, according to aspects of the disclosure;

FIG. 15 is a diagram illustrating an example of a technique for performing avatar animation, according to aspects of the disclosure;

FIG. 16 is a block diagram illustrating an example of a deep learning network, in accordance with some examples;

FIG. 17 is a block diagram illustrating an example of a convolutional neural network, in accordance with some examples;

FIG. 18 is a flow diagram illustrating an example of a process of generating virtual content in a distributed system, according to aspects of the disclosure;

FIG. 19 is a diagram illustrating an example of a computing system, according to aspects of the disclosure.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

As noted previously, an extended reality (XR) system or device can provide a user with an XR experience by presenting virtual content to the user (e.g., for a completely immersive experience) and/or can combine a view of a real-world or physical environment with a display of a virtual environment (made up of virtual content). The real-world environment can include real-world objects (also referred to as physical objects), such as people, vehicles, buildings, tables, chairs, and/or other real-world or physical objects. As used herein, the terms XR system and XR device are used interchangeably. Examples of XR systems or devices include head-mounted displays (HMDs), smart glasses (e.g., AR glasses, MR glasses, etc.), among others.

XR systems can include virtual reality (VR) systems facilitating interactions with VR environments, augmented reality (AR) systems facilitating interactions with AR environments, mixed reality (MR) systems facilitating interactions with MR environments, and/or other XR systems. For instance, VR provides a complete immersive experience in a three-dimensional (3D) computer-generated VR environment or video depicting a virtual version of a real-world environment. VR content can include VR video in some cases, which can be captured and rendered at very high quality, potentially providing a truly immersive virtual reality experience. Virtual reality applications can include gaming, training, education, sports video, online shopping, among others. VR content can be rendered and displayed using a VR system or device, such as a VR HMD or other VR headset, which fully covers a user's eyes during a VR experience.

AR is a technology that provides virtual or computer-generated content (referred to as AR content) over the user's view of a physical, real-world scene or environment. AR content can include any virtual content, such as video, images, graphic content, location data (e.g., global positioning system (GPS) data or other location data), sounds, any combination thereof, and/or other augmented content. An AR system is designed to enhance (or augment), rather than to replace, a person's current perception of reality. For example, a user can see a real stationary or moving physical object through an AR device display, but the user's visual perception of the physical object may be augmented or enhanced by a virtual image of that object (e.g., a real-world car replaced by a virtual image of a DeLorean), by AR content added to the physical object (e.g., virtual wings added to a live animal), by AR content displayed relative to the physical object (e.g., informational virtual content displayed near a sign on a building, a virtual coffee cup virtually anchored to (e.g., placed on top of) a real-world table in one or more images, etc.), and/or by displaying other types of AR content. Various types of AR systems can be used for gaming, entertainment, and/or other applications.

MR technologies can combine aspects of VR and AR to provide an immersive experience for a user. For example, in an MR environment, real-world and computer-generated objects can interact (e.g., a real person can interact with a virtual person as if the virtual person were a real person).

An XR environment can be interacted with in a seemingly real or physical way. As a user experiencing an XR environment (e.g., an immersive VR environment) moves in the real world, rendered virtual content (e.g., images rendered in a virtual environment in a VR experience) also changes, giving the user the perception that the user is moving within the XR environment. For example, a user can turn left or right, look up or down, and/or move forwards or backwards, thus changing the user's point of view of the XR environment. The XR content presented to the user can change accordingly, so that the user's experience in the XR environment is as seamless as it would be in the real world.

In some cases, an XR system can match the relative pose and movement of objects and devices in the physical world. For example, an XR system can use tracking information to calculate the relative pose of devices, objects, and/or features of the real-world environment in order to match the relative position and movement of the devices, objects, and/or the real-world environment. In some examples, the XR system can use the pose and movement of one or more devices, objects, and/or the real-world environment to render content relative to the real-world environment in a convincing manner. The relative pose information can be used to match virtual content with the user's perceived motion and the spatio-temporal state of the devices, objects, and real-world environment. In some cases, an XR system can track parts of the user (e.g., a hand and/or fingertips of a user) to allow the user to interact with items of virtual content.

XR systems or devices can facilitate interaction with different types of XR environments (e.g., a user can use an XR system or device to interact with an XR environment). One example of an XR environment is a metaverse virtual environment. A user may participate in one or more virtual sessions with other users by virtually interacting with other users (e.g., in a social setting, in a virtual meeting, etc.), virtually shopping for items (e.g., goods, services, property, etc.), virtually playing computer games, and/or experiencing other services in a metaverse virtual environment. In one illustrative example, a virtual session (also referred to as an XR session) provided by an XR system may include a 3D collaborative virtual environment for a group of users. The users may interact with one another via virtual representations of the users in the virtual environment. The users may visually, audibly, haptically, or otherwise experience the virtual environment while interacting with virtual representations of the other users.

A virtual representation of a user may be used to represent the user in a virtual environment. A virtual representation of a user is also referred to herein as an avatar. An avatar representing a user may mimic an appearance, movement, mannerisms, and/or other features of the user. A virtual representation or avatar may be generated/animated in real-time based on captured input from users' devices. Avatars may range from basic synthetic 3D representations to more realistic representations of the user. In some examples, the user may desire that the avatar representing the person in the virtual environment appear as a digital twin of the user. In any virtual environment, it is important for an XR system to efficiently generate high-quality avatars (e.g., realistically representing the appearance, movement, etc. of the person) in a low-latency manner. It can also be important for the XR system to render audio in an effective manner to enhance the XR experience.

For instance, in the example of the 3D collaborative virtual environment from above, an XR system a user from the group of users may display virtual representations (or avatars) of the other users sitting at specific locations at a virtual table or in a virtual room. The virtual representations of the users and the background of the virtual environment should be displayed in a realistic manner (e.g., as if the users were sitting together in the real world). The heads, bodies, arms, and hands of the users can be animated as the users move in the real world. Audio may need to be spatially rendered or may be rendered monophonically. Latency in rendering and animating the virtual representations should be minimal in order to maintain a high-quality user experience.

The computational complexity of generating virtual environments by XR systems can impose significant power and resource demands, which can be a limiting factor in implementing XR experiences (e.g., reducing the ability of XR devices to efficiently generate and animate virtual content in a low-latency manner). For example, the computational complexity of rendering and animating virtual representations of users and composing a virtual scene can impose large power and resource demands on devices when implementing XR applications. Such power and resource demands are exacerbated by recent trends towards implementing such technologies in mobile and wearable devices (e.g., HMDs, XR glasses, etc.), and making such devices smaller, lighter, and more comfortable (e.g., by reducing the heat emitted by the device) to wear by the user for longer periods of time.

In some aspects, before a virtual session is initiated, avatar information for a virtual representation (also referred to herein as an avatar representation), such as a base avatar representation, of a user is required to be available at, or downloaded by, a receiver device (e.g., an XR device) so that the receiver device can render the virtual representation of the user in the virtual session. For instance, the base avatar representation may be defined according to a standard (e.g., the Moving Picture Experts Group (MPEG) specified Avatar Representation Format (ARF)). A base avatar representation can be relatively large in size because it includes multiple components, such as a base mesh (e.g., polygonal model including a 3D mesh with a plurality of triangles made up of vertices and edges between the vertices), texture information (e.g., a UV mapping), blend shape meshes, joint pose animations, and various levels of details (LoD) for the different components.

A base mesh, as referenced herein, is a low-resolution, polygonal model that serves as a starting point for creating more detailed and complex 3D assets or avatars. UV mapping, as referenced herein, is a process of projecting a 3D model's surface onto a two-dimensional (2D) plane (also referenced herein as a UV map) to enable accurate and efficient texturing, essentially “unwrapping” the model to apply textures. Blend shape meshes, as described herein, refer to 3D animation objects used to deform a mesh by blending between different target shapes, allowing for smooth transitions and complex animations (e.g., for facial expressions). Joint pose animations, as described herein, refer to a specific key frame or pose of a character's skeleton, where the positions and rotations of the joints such as, elbows, knees, and/or shoulders, etc., are defined so that a distinct look or active is created.

In some examples, in a virtual session having N number of participants, a receiver device (e.g., an XR device) may need to download avatar information for base avatars associated with the other N−1 number of participants (all participants other than the receiver device). As a result, there may be a negative impact on the network or the system due to a virtual session set-up delay caused by each receiver device (N number of participants) needing to download all the base avatars for the other N−1 number of participants before the virtual session. Such a negative impact on the network or the system may further lead to a poor user experience.

In view of such factors, it may be difficult for an XR device (e.g., an HMD) of a user to render and animate virtual representations of other users and to compose a scene and generate a target view of a virtual environment for display to the user of the XR device.

Systems, apparatuses, electronic devices, methods (also referred to as processes), and computer-readable media (collectively referred to herein as “systems and techniques”) are described herein for providing distributed generation of virtual content for a virtual environment (e.g., a metaverse virtual environment). In some aspects, an animation and scene rendering system may receive input information associated with one or more devices (e.g., at least one XR device) of respective user(s) that are participating or associated with a virtual session (e.g., a 3D collaborative virtual meeting in a metaverse environment, a computer or virtual game, or other virtual session). For instance, the input information received from a first device may include information representing a face of a first user of the first device (e.g., codes or features representing an appearance of the face or other information), information representing a body of the first user of the first device (e.g., codes or features representing an appearance of the body, a pose of the body, or other information), information representing one or more hands of the first user of the device (e.g., codes or features representing an appearance of the hand(s), a pose of the hand(s), or other information), pose information of the first device (e.g., a pose in six-degrees-of-freedom (6-DOF), referred to as a 6-DOF pose), audio associated with an environment in which the first device is located, and/or other information.

The animation and scene rendering system may process the input information to generate and/or animate a respective virtual representation for each user of each device of the one or more devices. For example, the animation and scene rendering system may process the input information from the first device to generate and/or animate a virtual representation (or avatar) for the first user of the first device. Animation of a virtual representation refers to modifying a position, movement, mannerism, or other features of the virtual representation, such as to match a corresponding position, movement, mannerism, etc. of the corresponding user in a real-world or physical space. In some aspects, to generate and/or animate the virtual representation for the first user, the animation and scene rendering system may generate and/or animate a virtual representation of a face of the first user (referred to as a facial representation), generate and/or animate a virtual representation of a body of the first user (referred to as a body representation), and generate and/or animate a virtual representation of hair of the first user (referred to as a hair representation). In some cases, the animation and scene rendering system may combine or attach the facial representation with the body representation to generate a combined virtual representation. The animation and scene rendering system may then add the hair representation to the combined virtual representation to generate a final virtual representation of the user for one or more frames of content.

The animation and scene rendering system may then compose a virtual scene or environment for the virtual session and generate a respective target view (e.g., a frame of content, such as virtual content or a combination of real-world and virtual content) for each device from a respective perspective of each device or user in the virtual scene or environment. The composed virtual scene includes the virtual representations of the users involved in the virtual session and any virtual background of the scene. In one example, using the information received from the first device and information received from other devices of the one or more devices associated with the virtual session, the animation and scene rendering system may compose the virtual scene (including virtual representations of the users and background information) and generate a frame representing a view of the virtual scene from the perspective of a second user (representing a view of the second user in the real or physical world) of a second device of the one or more devices associated with the virtual session. In some aspects, the view of the virtual scene can be generated from the perspective of the second user based on a pose of the first device (corresponding to a pose of the first user) and poses of any other users/devices and also based on a pose of the second device (corresponding to a pose of the second user). For instance, the view of the virtual scene can be generated from the perspective of the second user based on a relative difference between the pose of the second device and each respective pose of the first device and the other devices.

The animation and scene rendering system can transmit the frame (e.g., after encoding or compressing the frame) to the second device. The second device can display the frame (e.g., after decoding or decompressing the frame) so that the second user can view the virtual scene from the second user's perspective.

In some cases, one or more meshes (e.g., including a plurality of vertices, edges, and/or faces in three-dimensional space) with corresponding materials may be used to represent an avatar. The materials may include a normal texture, a diffuse or albedo texture, a specular reflection texture, any combination thereof, and/or other materials or textures. The various materials or textures may need to be available from enrollment or offline reconstruction.

A goal of generating a virtual representation or avatar for a user is to generate a mesh with the various materials (e.g., normal, albedo, specular reflection, etc.) representing the user. In some cases, a mesh must be of a known topology. However, meshes from scanners (e.g., LightCage, 3DMD, etc.) may not satisfy such a constraint. To solve such an issue, a mesh can be retopologized after scanning, which would make the mesh parametrized (e.g., allowing the mesh to be animated using animation parameters).

For example, a mesh for a virtual representation (or avatar) may be associated with a number of animation parameters that define how the avatar will be animated during a virtual session. In some aspects, the animation parameters can include encoded parameters (e.g., codes or features) from a neural network, some or all of which can be used to generate the animated avatar. In some cases, the animation parameters can include facial part codes or features, codes or features representing face blend shapes, codes or features representing hand joints, codes or features representing body joints, codes or features representing head pose, an audio stream (or an encoded representation of the audio stream), any combination thereof, and/or other parameters. In some examples, to transmit data for an avatar mesh between devices for an interactive virtual experience between users, parameters for animating the mesh may be transmitted from one device of a first user or from a network device to a second device of a second user for every frame at a frame rate of 30-60 frames per second (FPS) so that the second device can animate the avatar at the frame rate.

In some aspects, systems and techniques described herein can perform, or use, split or hybrid rendering, gradual transitioning of rendering, mixed-rendering sessions, voice-only session starts, progressive or partial downloads, and/or pre-loaded base virtual representations (e.g., base avatars or avatar base models), as described in detail herein. As used herein, base avatar information for a base virtual representation (e.g., base avatar) is the information needed for a device (e.g., an XR device) to render a virtual representation (e.g., an avatar) for a user of a virtual session. Once the base avatar information is downloaded by the device, the device can begin rendering the virtual representation. A network device can then provide the animation parameters to the device so that the device can animate the virtual representation, as described herein.

For instance, in some aspects, a hybrid approach is used by a network (e.g., a network device) and one or more devices (e.g., XR devices). For example, the network device can more quickly obtain access to avatar information for base virtual representations (e.g., base avatar information for base avatars) of a plurality of users of devices (e.g., users of XR devices that can join a virtual session). The avatar information may be stored in a repository (e.g., a base avatar repository (BAR) and/or a database and/or other type of storage providing avatar assets) for which the network device has access (e.g., communicatively coupled with the network network). Based on accessing the avatar information in the repository, the network device can perform an initial rendering (e.g., multi-frame (MF) rendering) of one or more virtual representations (e.g., avatars) of one or more users. The rendered virtual representation(s) may be 2D or 3D avatar(s). Further, the network device can render a 2D and/or 3D avatar for a user based on the user's pose (e.g., as measured by a pose of the user's XR device while being worn on the head of the user).

While the virtual representation(s) of the user(s) is being rendered by the network device, avatar information of the other users' virtual representations (e.g., base avatar information of the other users' base avatars) may be downloaded in parallel by one or more of the devices (e.g., the XR devices). Once the full base avatar is downloaded, the one or more devices (e.g., XR devices) or another network device or entity from which the base avatar is downloaded (e.g., the BAR) can inform (e.g., by sending an indication to) the network device performing the rendering regarding completion of the download by the one or more devices. In some cases, if the two network devices are not the same entity, then the network device performing rendering can stop rendering of the virtual representation(s) of the users and the device(s) (e.g., the XR devices) can perform the required processing and/or rendering of the virtual representation(s) of the other user(s).

In some aspects, virtual representation(s) of the other user(s) (e.g., the 2D avatar or the 3D avatar) is performed through gradual transition from network device rendering to device rendering (e.g., XR device rendering). For example, a network device may first perform full rendering of virtual representation(s) of other user(s) of a virtual session while initial virtual representation(s) having a low-level of detail (e.g., a low-level detail face avatar) are being downloaded by a device (e.g., the XR device) that is part of the virtual session with the other user(s). Once the low-level detail virtual representation(s) are downloaded, the device or the network entity from which the low-level detail virtual representation(s) are downloaded (e.g., the BAR) may inform the network entity performing rendering regarding the completion of the download(s).

In some cases, avatar information downloaded by a first device (e.g., an XR device) for a virtual representation of a user of a second device for a virtual session can be associated with a base virtual representation of the user at a first level of quality. The first device can receive, from the network device, enhancement information (e.g., one or more enhancement layers) for the virtual representation of the user of the second device. The first device can generate a rendering of the virtual representation of the user of the second device at a second level of quality that is higher or greater than the first level of quality. For instance, the first device may begin generating a low-level detail rendering of the virtual representation of the user of the second device. The first device can request the network device to provide an enhancement layer so that the device (or the XR device) may start rendering the virtual representation of the user of the second device at a particular quality or resolution that is higher than the low-level detail rendering. Upon the network providing the enhancement layer, the device can apply the enhancement layer to the low-level detail rendering. In some examples, the enhancement information (e.g., the enhancement layer(s)) can include a higher-resolution texture map (e.g., UV map) that is higher than a texture map associated with the low-level detail rendering, an additional number of polygons (e.g., vertices and edges) for the 3D mesh, and/or other information that can increase the quality of a rendered virtual representation.

In some aspects, a base virtual representation (e.g., base avatar) of a user with low level of details may be a coarse animation (e.g., rendered as a cartoon character representation of the user), and with increasing level of details added to the base virtual representation, the virtual representation (or avatar) may begin to look like a more realistic version of the user (e.g., a photo-realistic version of the user). In some cases, the network device can generate high quality textures, and the device (or the XR device) may render the high quality texture with the avatar mesh. Additionally, or alternatively, the level of details may be enhanced by applying differentials (e.g., differential encoding) to the avatar mesh to enhance the level of detail. For instance, a differential encoding of the avatar mesh, as described herein, allows or enables encoding of a mesh with a higher level of detail (referred to as a higher level of detail (LoD) mesh) based on a mesh with a lower level of detail (a lower LoD mesh), such as by starting from the higher LoD and then collapsing edges to get to the lower LoD mesh. During the differential encoding, collapsed edges can be encoded as one or more differentials.

In some aspects, a base avatar with low level of details may be pre-stored on the device (e.g., on the XR device). Storing the base avatar with the low level of details on the device can limit the memory requirements the device needs to render virtual representations of users during a virtual session. Additionally, any privacy related risks associated with exposing an avatar with low level of details is low, such as when the low-level detail avatar does not realistically represent a user's appearance. In such aspects, the network device may provide supplemental avatar information (e.g., with higher levels of detail) to the device (or the XR device) for rendering the virtual representations (or rendering the virtual content or rendering the virtual scenes). Rendering the virtual representations (or rendering the virtual content or rendering the virtual scenes) can include compositing received renderings into a locally displayed scene, or locally rendering the 3D scene once assets are available.

In some aspects, in order to save power consumption (e.g., when operating in a system with devices having limited computing resources, such as XR devices), the split rendering configuration discussed above may be a preferred operational mode for the network and/or the device (e.g., the XR device). Additionally, or alternatively, the device (or the XR device) may continue to download higher levels of details for the base avatar and the network device may continue with reducing the amount of information that the network device transmits to the device as the device increases the level of details of virtual representations the device is rendering.

In some aspects, a virtual session may be implemented as a mixed-rendering session. In the mixed-rendering session, the device (e.g., the XR device) and the network device may each render a subset of virtual representations of users participating in a virtual session. For example, the device (e.g., the XR device) may perform local rendering (on the device) of virtual representation(s) of one or more users (participants) of the XR session, while the network device can render virtual representation(s) of one or more other users (participants) of the virtual session. The network device can transmit rendering(s) of the virtual representation(s) of one or more other users to the device so that the device can render a virtual scene including the virtual representations of the user(s) and the other user(s). At least one benefit of such mixed-rendering session is reduction in a number of base avatars that the device (or the XR device) needs to download. The mixed-rendering session can thus provide significant improvement for devices (e.g., XR devices) having a limited amount of computing power (e.g., devices that can only render a certain number of avatars).

In some aspects, a virtual session may be started as a voice only session for an initial duration of the virtual session during which base avatar information may be downloaded in parallel, and/or in the background (e.g., as the voice only session is occurring). Upon completion of downloading of an initial base avatar, the virtual session may be changed to a video virtual session with renderings of virtual representations of users displayed during the virtual session.

In some cases, a base virtual representation (e.g., a base avatar) may be encoded such that a quality of the base virtual representation may increase gradually while a device (e.g., an XR device) is downloading the base virtual representation data. In such progressive downloading (also referred to as progressive storage), the quality of the base virtual representation may initially be poor and may become better once a certain threshold amount of avatar information is downloaded. In some aspects, during progressive downloading, views may be restricted and/or only the initially visible part of a virtual representation may be downloaded.

In some aspects, for a multi-part XR session, only base avatar models that are currently in the view are downloaded and gradually refined. In some cases, either the network device (e.g., a server) or the device (e.g., a client such as an XR device) may negotiate or determine scheduling or prioritization regarding downloading and/or refining the base avatar model information.

In some examples, the initial representation that is downloaded may depend on certain parameters, such as on the initial viewpoint (e.g., only a forehead of a user's virtual representation is downloaded, while the rest of the head and/or the body is downloaded at a later point).

In some aspects, base virtual representations (e.g., base avatar models) of one or more virtual session participants may be pre-loaded on a device (e.g., an XR device). For example, the one or more virtual session participants may be frequent participants of a virtual session with a user of the device stored in a contact list on the device (e.g., under a particular category such as, friends, family, etc.), etc. In order to improve security of the pre-loaded base virtual representations on the device, the storage area may be secured and accessed using authentication information (e.g., a password, a pin, a fingerprint, face recognition credentials, etc.). In some cases, the pre-loaded base virtual representations may be updated or changed when there is an update in the information of the base virtual representations. For example, a change in hair, appearance, etc., may result in updated information to be downloaded and stored on the device memory (or the XR device memory).

Various aspects of the application will be described with respect to the figures.

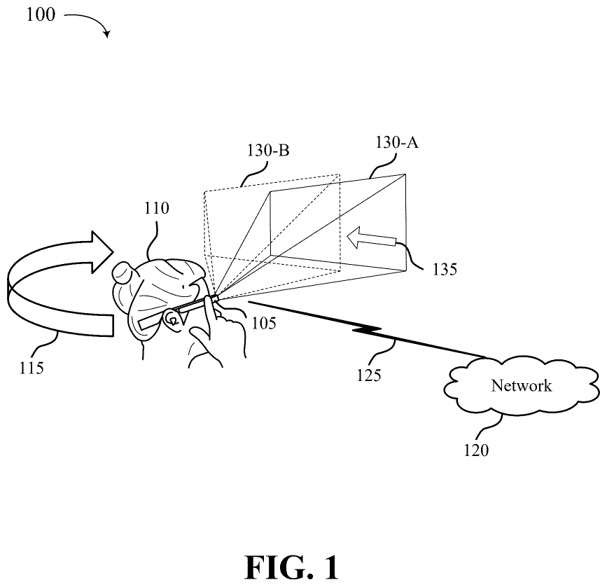

FIG. 1 illustrates an example of an extended reality system 100. As shown, the extended reality system 100 includes a device 105, a network 120, and a communication link 125. In some cases, the device 105 may be an extended reality (XR) device, which may generally implement aspects of extended reality, including virtual reality (VR), augmented reality (AR), mixed reality (MR), etc. Systems including a device 105, a network 120, or other elements in extended reality system 100 may be referred to as extended reality systems.

The device 105 may overlay virtual objects with real-world objects in a view 130. For example, the view 130 may generally refer to visual input to a user 110 via the device 105, a display generated by the device 105, a configuration of virtual objects generated by the device 105, etc. For example, view 130-A may refer to visible real-world objects (also referred to as physical objects) and visible virtual objects, overlaid on or coexisting with the real-world objects, at some initial time. View 130-B may refer to visible real-world objects and visible virtual objects, overlaid on or coexisting with the real-world objects, at some later time. As discussed herein, positional differences in real-world objects (e.g., overlaid virtual objects) may arise from view 130-A shifting to view 130-B at 135 due to head motion 115. In another example, view 130-A may refer to a completely virtual environment or scene at the initial time and view 130-B may refer to the virtual environment or scene at the later time.

Generally, device 105 may generate, display, project, etc. virtual objects, and/or a virtual environment to be viewed by a user 110 (e.g., where virtual objects and/or a portion of the virtual environment may be displayed based on user 110 head pose prediction in accordance with the techniques described herein). In some examples, the device 105 may include a transparent surface (e.g., optical glass) such that virtual objects may be displayed on the transparent surface to overlay virtual objects on real word objects viewed through the transparent surface. Additionally, or alternatively, the device 105 may project virtual objects onto the real-world environment. In some cases, the device 105 may include a camera and may display both real-world objects (e.g., as frames or images captured by the camera) and virtual objects overlaid on displayed real-world objects. In various examples, device 105 may include aspects of a virtual reality headset, smart glasses, a live feed video camera, a GPU, one or more sensors (e.g., such as one or more IMUs, image sensors, microphones, etc.), one or more output devices (e.g., such as speakers, display, smart glass, etc.), etc.

In some cases, head motion 115 may include user 110 head rotations, translational head movement, etc. The device 105 may update the view 130 of the user 110 according to the head motion 115. For example, the device 105 may display view 130-A for the user 110 before the head motion 115. In some cases, after the head motion 115, the device 105 may display view 130-B to the user 110. The extended reality system (e.g., device 105) may render or update the virtual objects and/or other portions of the virtual environment for display as the view 130-A shifts to view 130-B.

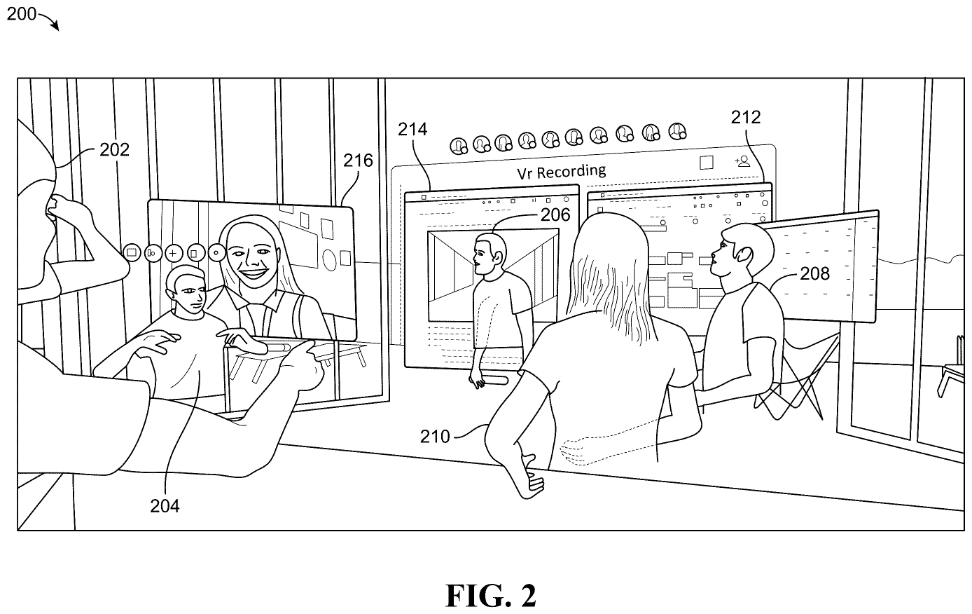

In some cases, the extended reality system 100 may provide various types of virtual experiences, such as a three-dimensional (3D) collaborative virtual environment for a group of users (e.g., including the user 110). FIG. 2 is a diagram illustrating an example of a 3D collaborative virtual environment 200 in which various users interact with one another in a virtual session via virtual representations (or avatars) of the users in the virtual environment 200. The virtual representations include including a virtual representation 202 of a first user, a virtual representation 204 of a second user, a virtual representation 206 of a third user, a virtual representation 208 of a fourth user, and a virtual representation 210 of a fifth user. Other background information of the virtual environment 200 is also shown, including a virtual calendar 212, a virtual web page 214, and a virtual video conference interface 216. The users may visually, audibly, haptically, or otherwise experience the virtual environment from each user's perspective while interacting with the virtual representations of the other users. For example, the virtual environment 200 is shown from the perspective of the first user (represented by the virtual representation 202).

It is important for an XR system to efficiently generate high-quality virtual representations (or avatars) with low latency. It can also be important for the XR system to render audio in an effective manner to enhance the XR experience. For instance, in the example of the 3D collaborative virtual environment 200 of FIG. 2, an XR system of the first user (e.g., the XR system 100) displays the virtual representations 204-210 of the other users participating in the virtual session. The virtual representations 204-210 of the users and the background of the virtual environment 200 should be displayed in a realistic manner (e.g., as if the users were meeting in a real-world environment), such as by animating the heads, bodies, arms, and hands of the other users' virtual representations 204-210 as the users move in the real world. Audio captured by XR systems of the other users may need to be spatially rendered or may be rendered monophonically for output to the XR system of the first user. Latency in rendering and animating the virtual representations 204-210 should be minimal so that user experience of the first user is as if the user is interacting with the other users in the real-world environment.

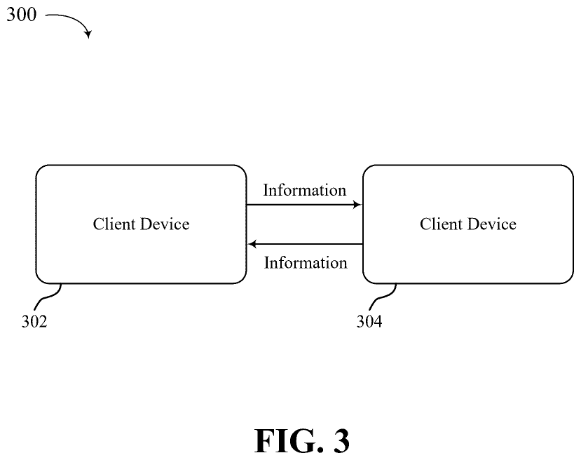

Extended reality systems typically involve the XR devices (e.g., an HMD, smart glasses such as AR glasses, etc.) rendering and animating virtual representations of users and composing a virtual scene. FIG. 3 is a diagram illustrating an example of an extended reality system 300 in which two client devices (client device 302 and client device 304) exchange information used to generate (e.g., render and/or animate) virtual representations of users and compose a virtual scene including the virtual representations of the users (e.g., the virtual environment 200). For example, the client device 302 may transmit pose information to the client device 304. The client device 304 can use the pose information to generate a rendering of a virtual representation of a user of the client device 302 from the perspective of the client device 304.

However, the computational complexity of generating virtual environments can introduce significant power and resource demands on the client devices 302, 304, leading to excessing power and resource demands on the client devices when implementing XR applications. Such complexity can limit an ability of a client device to generate an XR experience in a high-quality and low-latency manner. These power and resource demands are intensified due to XR technologies typically being implemented in mobile and wearable devices (e.g., HMDs, XR glasses, etc.), which are being manufactured with smaller, lighter, and more comfortable (e.g., by reducing the heat emitted by the device) form factors, with the idea that a user may wear an XR device for long periods of time. In view of such issues, it may be difficult for an XR system 300 such as that shown in FIG. 3 to provide a quality XR experience.

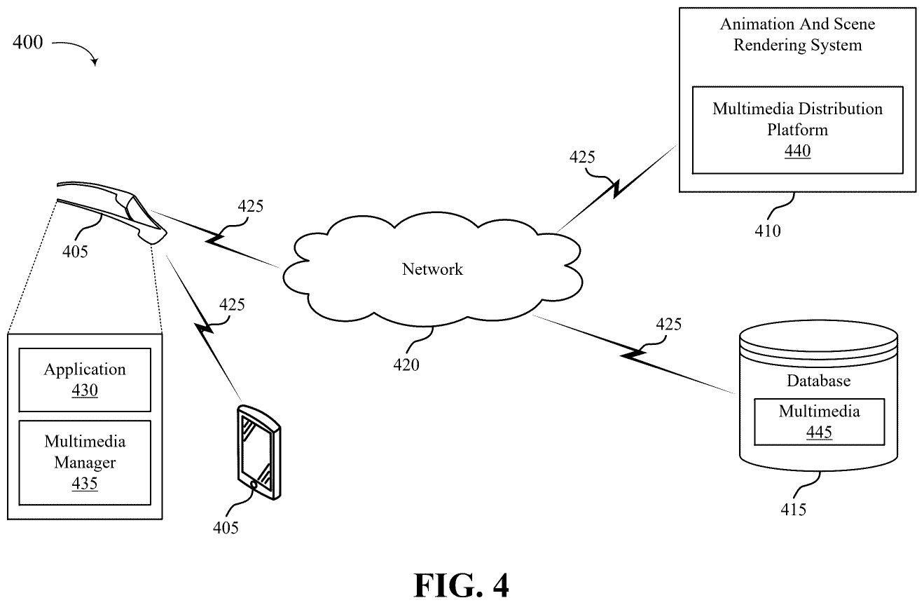

As noted previously, systems and techniques are described herein for providing distributed generation of virtual content for a virtual environment or scene (e.g., a metaverse virtual environment). FIG. 4 is a diagram illustrating an example of a system 400 in accordance with aspects of the present disclosure. As shown, the system 400 includes client devices 405, an animation and scene rendering system 410, and storage 415. Although the system 400 illustrates two devices 405, a single animation and scene rendering system 410, a single storage 415, and a single network 420, the present disclosure applies to any system architecture having one or more devices 405, animation and scene rendering systems 410, storage 415, and networks 420. In some cases, the storage 415 may be part of the animation and scene rendering system 410. The devices 405, the animation and scene rendering system 410, and the storage 415 may communicate with each other and exchange information that supports generation of virtual content for XR, such as multimedia packets, multimedia data, multimedia control information, pose prediction parameters, via network 420 using communications links 425. In some cases, a portion of the techniques described herein for providing distributed generation of virtual content may be performed by one or more of the devices 405 and a portion of the techniques may be performed by the animation and scene rendering system 410, or both.

A device 405 may be an XR device (e.g., a head-mounted display (HMD), XR glasses such as virtual reality (VR) glasses, augmented reality (AR) glasses, etc.), a mobile device (e.g., a cellular phone, a smartphone, a personal digital assistant (PDA), etc.), a wireless communication device, a tablet computer, a laptop computer, and/or other device that supports various types of communication and functional features related to multimedia (e.g., transmitting, receiving, broadcasting, streaming, sinking, capturing, storing, and recording multimedia data). A device 405 may, additionally or alternatively, be referred to by those skilled in the art as a user equipment (UE), a user device, a smartphone, a Bluetooth device, a Wi-Fi device, a mobile station, a subscriber station, a mobile unit, a subscriber unit, a wireless unit, a remote unit, a mobile device, a wireless device, a wireless communications device, a remote device, an access terminal, a mobile terminal, a wireless terminal, a remote terminal, a handset, a user agent, a mobile client, a client, and/or some other suitable terminology. In some cases, the devices 405 may also be able to communicate directly with another device (e.g., using a peer-to-peer (P2P) or device-to-device (D2D) protocol, such as sidelink communications). For example, a device 405 may be able to receive from or transmit to another device 405 variety of information, such as instructions or commands (e.g., multimedia-related information).

The devices 405 may include an application 430 and a multimedia manager 435. While the system 400 illustrates the devices 405 including both the application 430 and the multimedia manager 435, the application 430 and the multimedia manager 435 may be an optional feature for the devices 405. In some cases, the application 430 may be a multimedia-based application that can receive (e.g., download, stream, broadcast) from the animation and scene rendering systems 410, storage 415 or another device 405, or transmit (e.g., upload) multimedia data to the animation and scene rendering systems 410, the storage 415, or to another device 405 via using communications links 425.

The multimedia manager 435 may be part of a general-purpose processor, a digital signal processor (DSP), an image signal processor (ISP), a central processing unit (CPU), a graphics processing unit (GPU), a microcontroller, an application-specific integrated circuit (ASIC), a field-programmable gate array (FPGA), a discrete gate or transistor logic component, a discrete hardware component, or any combination thereof, or other programmable logic device, discrete gate or transistor logic, discrete hardware components, or any combination thereof designed to perform the functions described in the present disclosure, and/or the like. For example, the multimedia manager 435 may process multimedia (e.g., image data, video data, audio data) from and/or write multimedia data to a local memory of the device 405 or to the storage 415.

The multimedia manager 435 may also be configured to provide multimedia enhancements, multimedia restoration, multimedia analysis, multimedia compression, multimedia streaming, and multimedia synthesis, among other functionalities. For example, the multimedia manager 435 may perform white balancing, cropping, scaling (e.g., multimedia compression), adjusting a resolution, multimedia stitching, color processing, multimedia filtering, spatial multimedia filtering, artifact removal, frame rate adjustments, multimedia encoding, multimedia decoding, and multimedia filtering. By further example, the multimedia manager 435 may process multimedia data to support server-based pose prediction for XR, according to the techniques described herein.

The animation and scene rendering system 410 may be a server device, such as a data server, a cloud server, a server associated with a multimedia subscription provider, proxy server, web server, application server, communications server, home server, mobile server, edge or cloud-based server, a personal computer acting as a server device, a mobile device such as a mobile phone acting as a server device, an XR device acting as a server device, a network router, any combination thereof, or other server device. The animation and scene rendering system 410 may in some cases include a multimedia distribution platform 440. In some cases, the multimedia distribution platform 440 may be a separate device or system from the animation and scene rendering system 410. The multimedia distribution platform 440 may allow the devices 405 to discover, browse, share, and download multimedia via network 420 using communications links 425, and therefore provide a digital distribution of the multimedia from the multimedia distribution platform 440. As such, a digital distribution may be a form of delivering media content such as audio, video, images, without the use of physical media but over online delivery mediums, such as the Internet. For example, the devices 405 may upload or download multimedia-related applications for streaming, downloading, uploading, processing, enhancing, etc. multimedia (e.g., images, audio, video). The animation and scene rendering system 410 or the multimedia distribution platform 440 may also transmit to the devices 405 a variety of information, such as instructions or commands (e.g., multimedia-related information) to download multimedia-related applications on the device 405.

The storage 415 may store a variety of information, such as instructions or commands (e.g., multimedia-related information). For example, the storage 415 may store multimedia 445, data of a base avatar respective to each participant of a plurality of participants of an XR session, information from devices 405 (e.g., pose information, representation information for virtual representations or avatars of users, such as codes or features related to facial representations, body representations, hand representations, etc., and/or other information). A device 405 and/or the animation and scene rendering system 410 may retrieve the stored data from the storage 415 and/or more send data to the storage 415 via the network 420 using communication links 425. In some examples, the storage 415 may be a memory device (e.g., read only memory (ROM), random access memory (RAM), cache memory, buffer memory, etc.), a relational database (e.g., a relational database management system (RDBMS) or a Structured Query Language (SQL) database), a non-relational database, a network database, an object-oriented database, or other type of database, that stores the variety of information, such as instructions or commands (e.g., multimedia-related information).

The network 420 may provide encryption, access authorization, tracking, Internet Protocol (IP) connectivity, and other access, computation, modification, and/or functions. Examples of network 420 may include any combination of cloud networks, local area networks (LAN), wide area networks (WAN), virtual private networks (VPN), wireless networks (using 802.11, for example), cellular networks (using third generation (3G), fourth generation (4G), long-term evolved (LTE), or new radio (NR) systems (e.g., fifth generation (5G)), etc. Network 420 may include the Internet.

The communications links 425 shown in the system 400 may include uplink transmissions from the device 405 to the animation and scene rendering systems 410 and the storage 415, and/or downlink transmissions, from the animation and scene rendering systems 410 and the storage 415 to the device 405. The wireless links 425 may transmit bidirectional communications and/or unidirectional communications. In some examples, the communication links 425 may be a wired connection or a wireless connection, or both. For example, the communications links 425 may include one or more connections, including but not limited to, Wi-Fi, Bluetooth, Bluetooth low-energy (BLE), cellular, Z-WAVE, 802.11, peer-to-peer, LAN, wireless local area network (WLAN), Ethernet, FireWire, fiber optic, and/or other connection types related to wireless communication systems.

In some aspects, a user of the device 405 (referred to as a first user) may be participating in a virtual session (also referenced herein as an XR session) with one or more other users (including a second user of an additional device). In such examples, the animation and scene rendering systems 410 may process information received from the device 405 (e.g., received directly from the device 405, received from storage 415, etc.) to generate and/or animate a virtual representation (or avatar) for the first user. The animation and scene rendering systems 410 may compose a virtual scene that includes the virtual representation of the user and in some cases background virtual information from a perspective of the second user of the additional device. The animation and scene rendering systems 410 may transmit (e.g., via network 120) a frame of the virtual scene to the additional device. Further details regarding such aspects are provided below.

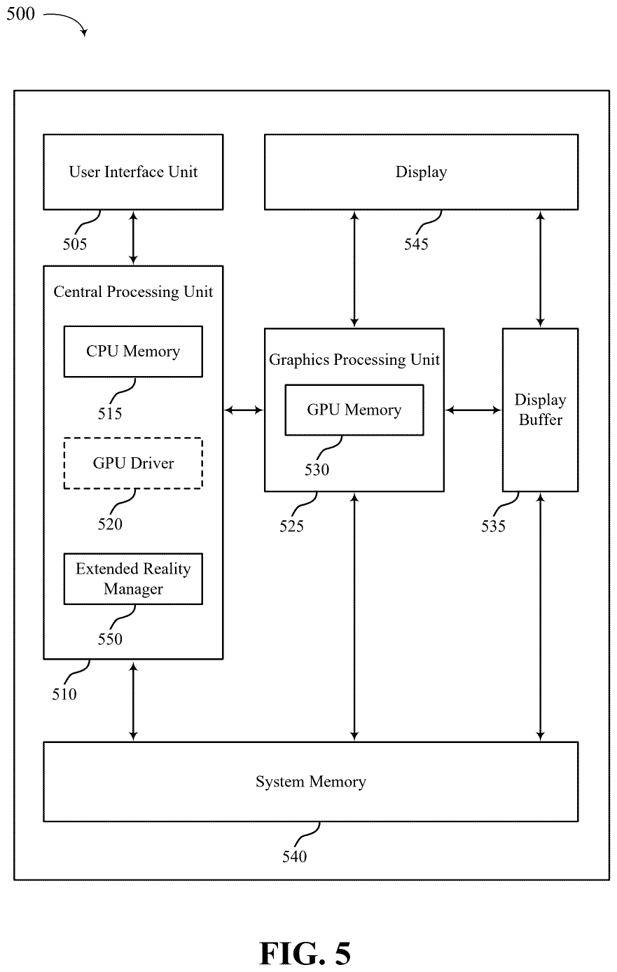

FIG. 5 is a diagram illustrating an example of a device 500. The device 500 can be implemented as a client device (e.g., device 405 of FIG. 4) or as an animation and scene rendering system (e.g., the animation and scene rendering system 410). As shown, the device 500 includes a central processing unit (CPU) 510 having CPU memory 515, a GPU 525 having GPU memory 530, a display 545, a display buffer 535 storing data associated with rendering, a user interface unit 505, and a system memory 540. For example, system memory 540 may store a GPU driver 520 (illustrated as being contained within CPU 510 as described below) having a compiler, a GPU program, a locally-compiled GPU program, and the like. User interface unit 505, CPU 510, GPU 525, system memory 540, display 545, and extended reality manager 550 may communicate with each other (e.g., using a system bus).

Examples of CPU 510 include, but are not limited to, a digital signal processor (DSP), general purpose microprocessor, application specific integrated circuit (ASIC), field programmable logic array (FPGA), or other equivalent integrated or discrete logic circuitry. Although CPU 510 and GPU 525 are illustrated as separate units in the example of FIG. 5, in some examples, CPU 510 and GPU 525 may be integrated into a single unit. CPU 510 may execute one or more software applications. Examples of the applications may include operating systems, word processors, web browsers, e-mail applications, spreadsheets, video games, audio and/or video capture, playback or editing applications, or other such applications that initiate the generation of image data to be presented via display 545. As illustrated, CPU 510 may include CPU memory 515. For example, CPU memory 515 may represent on-chip storage or memory used in executing machine or object code. CPU memory 515 may include one or more volatile or non-volatile memories or storage devices, such as flash memory, a magnetic data media, an optical storage media, etc. CPU 510 may be able to read values from or write values to CPU memory 515 more quickly than reading values from or writing values to system memory 540, which may be accessed, e.g., over a system bus.

GPU 525 may represent one or more dedicated processors for performing graphical operations. For example, GPU 525 may be a dedicated hardware unit having fixed function and programmable components for rendering graphics and executing GPU applications. GPU 525 may also include a DSP, a general purpose microprocessor, an ASIC, an FPGA, or other equivalent integrated or discrete logic circuitry. GPU 525 may be built with a highly-parallel structure that provides more efficient processing of complex graphic-related operations than CPU 510. For example, GPU 525 may include a plurality of processing elements that are configured to operate on multiple vertices or pixels in a parallel manner. The highly parallel nature of GPU 525 may allow GPU 525 to generate graphic images (e.g., graphical user interfaces and two-dimensional or three-dimensional graphics scenes) for display 545 more quickly than CPU 510.

GPU 525 may, in some instances, be integrated into a motherboard of device 500. In other instances, GPU 525 may be present on a graphics card or other device or component that is installed in a port on the motherboard of device 500 or may be otherwise incorporated within a peripheral device configured to interoperate with device 500. As illustrated, GPU 525 may include GPU memory 530. For example, GPU memory 530 may represent on-chip storage or memory used in executing machine or object code. GPU memory 530 may include one or more volatile or non-volatile memories or storage devices, such as flash memory, a magnetic data media, an optical storage media, etc. GPU 525 may be able to read values from or write values to GPU memory 530 more quickly than reading values from or writing values to system memory 540, which may be accessed, e.g., over a system bus. That is, GPU 525 may read data from and write data to GPU memory 530 without using the system bus to access off-chip memory. This operation may allow GPU 525 to operate in a more efficient manner by reducing the need for GPU 525 to read and write data via the system bus, which may experience heavy bus traffic.

Display 545 represents a unit capable of displaying video, images, text, or any other type of data for consumption by a viewer. In some cases, such as when the device 500 is implemented as an animation and scene rendering system, the device 500 may not include the display 545. The display 545 may include a liquid-crystal display (LCD), a light emitting diode (LED) display, an organic LED (OLED), an active-matrix OLED (AMOLED), or the like. Display buffer 535 represents a memory or storage device dedicated to storing data for presentation of imagery, such as computer-generated graphics, still images, video frames, or the like for display 545. Display buffer 535 may represent a two-dimensional buffer that includes a plurality of storage locations. The number of storage locations within display buffer 535 may, in some cases, generally correspond to the number of pixels to be displayed on display 545. For example, if display 545 is configured to include 640×480 pixels, display buffer 535 may include 640×480 storage locations storing pixel color and intensity information, such as red, green, and blue pixel values, or other color values. Display buffer 535 may store the final pixel values for each of the pixels processed by GPU 525. Display 545 may retrieve the final pixel values from display buffer 535 and display the final image based on the pixel values stored in display buffer 535.

User interface unit 505 represents a unit with which a user may interact with or otherwise interface to communicate with other units of device 500, such as CPU 510. Examples of user interface unit 505 include, but are not limited to, a trackball, a mouse, a keyboard, and other types of input devices. User interface unit 505 may also be, or include, a touch screen and the touch screen may be incorporated as part of display 545.

System memory 540 may include one or more computer-readable storage media. Examples of system memory 540 include, but are not limited to, a random access memory (RAM), static RAM (SRAM), dynamic RAM (DRAM), a read-only memory (ROM), an electrically erasable programmable read-only memory (EEPROM), a compact disc read-only memory (CD-ROM) or other optical disc storage, magnetic disc storage, or other magnetic storage devices, flash memory, or any other medium that can be used to store desired program code in the form of instructions or data structures and that can be accessed by a computer or a processor. System memory 540 may store program modules and/or instructions that are accessible for execution by CPU 510. Additionally, system memory 540 may store user applications and application surface data associated with the applications. System memory 540 may in some cases store information for use by and/or information generated by other components of device 500. For example, system memory 540 may act as a device memory for GPU 525 and may store data to be operated on by GPU 525 as well as data resulting from operations performed by GPU 525.

In some examples, system memory 540 may include instructions that cause CPU 510 or GPU 525 to perform the functions ascribed to CPU 510 or GPU 525 in aspects of the present disclosure. System memory 540 may, in some examples, be considered as a non-transitory storage medium. The term “non-transitory” should not be interpreted to mean that system memory 540 is non-movable. As one example, system memory 540 may be removed from device 500 and moved to another device. As another example, a system memory substantially similar to system memory 540 may be inserted into device 500. In certain examples, a non-transitory storage medium may store data that can, over time, change (e.g., in RAM).

System memory 540 may store a GPU driver 520 and compiler, a GPU program, and a locally-compiled GPU program. The GPU driver 520 may represent a computer program or executable code that provides an interface to access GPU 525. CPU 510 may execute the GPU driver 520 or portions thereof to interface with GPU 525 and, for this reason, GPU driver 520 is shown in the example of FIG. 5 within CPU 510. GPU driver 520 may be accessible to programs or other executables executed by CPU 510, including the GPU program stored in system memory 540. Thus, when one of the software applications executing on CPU 510 requires graphics processing, CPU 510 may provide graphics commands and graphics data to GPU 525 for rendering to display 545 (e.g., via GPU driver 520).

In some cases, the GPU program may include code written in a high level (HL) programming language, e.g., using an application programming interface (API). Examples of APIs include Open Graphics Library (“OpenGL”), DirectX, Render-Man, WebGL, or any other public or proprietary standard graphics API. The instructions may also conform to so-called heterogeneous computing libraries, such as Open-Computing Language (“OpenCL”), DirectCompute, etc. In general, an API includes a predetermined, standardized set of commands that are executed by associated hardware. API commands allow a user to instruct hardware components of a GPU 525 to execute commands without user knowledge as to the specifics of the hardware components. In order to process the graphics rendering instructions, CPU 510 may issue one or more rendering commands to GPU 525 (e.g., through GPU driver 520) to cause GPU 525 to perform some or all of the rendering of the graphics data. In some examples, the graphics data to be rendered may include a list of graphics primitives (e.g., points, lines, triangles, quadrilaterals, etc.).

The GPU program stored in system memory 540 may invoke or otherwise include one or more functions provided by GPU driver 520. CPU 510 generally executes the program in which the GPU program is embedded and, upon encountering the GPU program, passes the GPU program to GPU driver 520. CPU 510 executes GPU driver 520 in this context to process the GPU program. That is, for example, GPU driver 520 may process the GPU program by compiling the GPU program into object or machine code executable by GPU 525. This object code may be referred to as a locally-compiled GPU program. In some examples, a compiler associated with GPU driver 520 may operate in real-time or near-real-time to compile the GPU program during the execution of the program in which the GPU program is embedded. For example, the compiler generally represents a unit that reduces HL instructions defined in accordance with a HL programming language to low-level (LL) instructions of a LL programming language. After compilation, these LL instructions are capable of being executed by specific types of processors or other types of hardware, such as FPGAs, ASICs, and the like (including, but not limited to, CPU 510 and GPU 525).

In the example of FIG. 5, the compiler may receive the GPU program from CPU 510 when executing HL code that includes the GPU program. That is, a software application being executed by CPU 510 may invoke GPU driver 520 (e.g., via a graphics API) to issue one or more commands to GPU 525 for rendering one or more graphics primitives into displayable graphics images. The compiler may compile the GPU program to generate the locally-compiled GPU program that conforms to a LL programming language. The compiler may then output the locally-compiled GPU program that includes the LL instructions. In some examples, the LL instructions may be provided to GPU 525 in the form a list of drawing primitives (e.g., triangles, rectangles, etc.).

The LL instructions (e.g., which may alternatively be referred to as primitive definitions) may include vertex specifications that specify one or more vertices associated with the primitives to be rendered. The vertex specifications may include positional coordinates for each vertex, and, in some instances, other attributes associated with the vertex, such as color coordinates, normal vectors, and texture coordinates. The primitive definitions may include primitive type information, scaling information, rotation information, and the like. Based on the instructions issued by the software application (e.g., the program in which the GPU program is embedded), GPU driver 520 may formulate one or more commands that specify one or more operations for GPU 525 to perform in order to render the primitive. When GPU 525 receives a command from CPU 510, it may decode the command and configure one or more processing elements to perform the specified operation and may output the rendered data to display buffer 535.

GPU 525 may receive the locally-compiled GPU program, and then, in some instances, GPU 525 renders one or more images and outputs the rendered images to display buffer 535. For example, GPU 525 may generate a number of primitives to be displayed at display 545. Primitives may include one or more of a line (including curves, splines, etc.), a point, a circle, an ellipse, a polygon (e.g., a triangle), or any other two-dimensional primitive. The term “primitive” may also refer to three-dimensional primitives, such as cubes, cylinders, sphere, cone, pyramid, torus, or the like. Generally, the term “primitive” refers to any basic geometric shape or element capable of being rendered by GPU 525 for display as an image (or frame in the context of video data) via display 545. GPU 525 may transform primitives and other attributes (e.g., that define a color, texture, lighting, camera configuration, or other aspect) of the primitives into a so-called “world space” by applying one or more model transforms (which may also be specified in the state data). Once transformed, GPU 525 may apply a view transformation for the active camera (which again may also be specified in the state data defining the camera) to transform the coordinates of the primitives and lights into the camera or eye space. GPU 525 may also perform vertex shading to render the appearance of the primitives in view of any active lights. GPU 525 may perform vertex shading in one or more of the above model, world, or view space.

Once the primitives are shaded, GPU 525 may perform projections to project the image into a canonical view volume. After transforming the model from the eye space to the canonical view volume, GPU 525 may perform clipping to remove any primitives that do not at least partially reside within the canonical view volume. For example, GPU 525 may remove any primitives that are not within the frame of the camera. GPU 525 may then map the coordinates of the primitives from the view volume to the screen space, effectively reducing the three-dimensional coordinates of the primitives to the two-dimensional coordinates of the screen. Given the transformed and projected vertices defining the primitives with their associated shading data, GPU 525 may then rasterize the primitives. Generally, rasterization may refer to the task of taking an image described in a vector graphics format and converting it into a raster image (e.g., a pixelated image) for output on a video display or for storage in a bitmap file format.

A GPU 525 may include a dedicated fast bin buffer (e.g., a fast memory buffer, such as GMEM, which may be referred to by GPU memory 530). As discussed herein, a rendering surface may be divided into bins. In some cases, the bin size is determined by format (e.g., pixel color and depth information) and render target resolution divided by the total amount of GMEM. The number of bins may vary based on device 500 hardware, target resolution size, and target display format. A rendering pass may draw (e.g., render, write, etc.) pixels into GMEM (e.g., with a high bandwidth that matches the capabilities of the GPU). The GPU 525 may then resolve the GMEM (e.g., burst write blended pixel values from the GMEM, as a single layer, to a display buffer 535 or a frame buffer in system memory 540). Such may be referred to as bin-based or tile-based rendering. When all bins are complete, the driver may swap buffers and start the binning process again for a next frame.

For example, GPU 525 may implement a tile-based architecture that renders an image or rendering target by breaking the image into multiple portions, referred to as tiles or bins. The bins may be sized based on the size of GPU memory 530 (e.g., which may alternatively be referred to herein as GMEM or a cache), the resolution of display 545, the color or Z precision of the render target, etc. When implementing tile-based rendering, GPU 525 may perform a binning pass and one or more rendering passes. For example, with respect to the binning pass, GPU 525 may process an entire image and sort rasterized primitives into bins.

The device 500 may use sensor data, sensor statistics, or other data from one or more sensors. Some examples of the monitored sensors may include IMUs, eye trackers, tremor sensors, heart rate sensors, etc. In some cases, an IMU may be included in the device 500, and may measure and report a body's specific force, angular rate, and sometimes the orientation of the body, using some combination of accelerometers, gyroscopes, or magnetometers.

As shown, device 500 may include an extended reality manager 550. The extended reality manager 550 may implement aspects of extended reality, augmented reality, virtual reality, etc. In some cases, such as when the device 500 is implemented as a client device (e.g., device 405 of FIG. 4), the extended reality manager 550 may determine information associated with a user of the device and/or a physical environment in which the device 500 is located, such as facial information, body information, hand information, device pose information, audio information, etc. The device 500 may transmit the information to an animation and scene rendering system (e.g., animation and scene rendering system 410). In some cases, such as when the device 500 is implemented as an animation and scene rendering system (e.g., the animation and scene rendering system 410 of FIG. 4), the extended reality manager 550 may process the information provided by a client device as input information to generate and/or animate a virtual representation for a user of the client device.

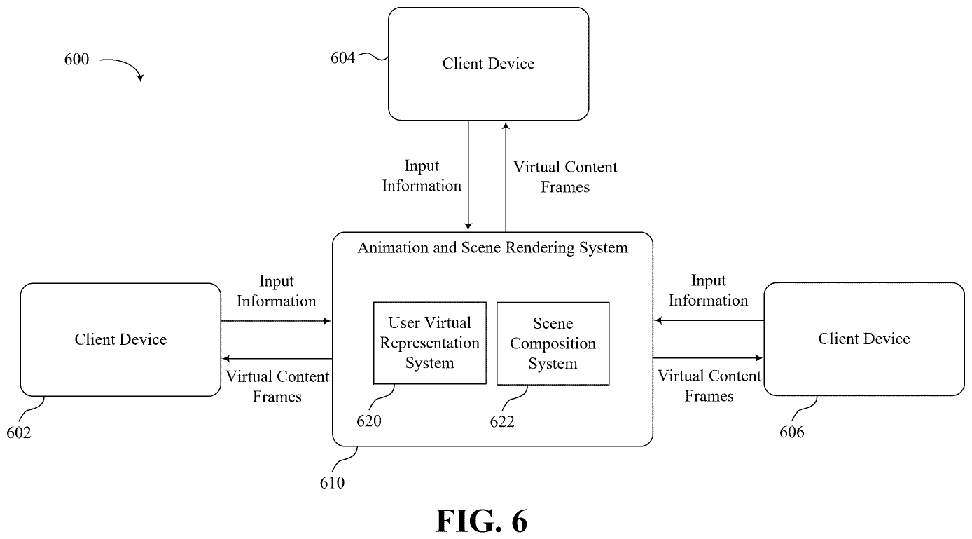

FIG. 6 is a diagram illustrating another example of an XR system 600 that includes a client device 602, a client device 604, and a client device 606 in communication with an animation and scene rendering system 610. As shown, each of the client devices 602, 604, and 606 provides input information to the animation and scene rendering system 610. In some examples, the input information from the client device 602 may include information representing a face (e.g., codes or features representing an appearance of the face or other information) of a user of the client device 602, information representing a body (e.g., codes or features representing an appearance of the body, a pose of the body, or other information) of the user of the client device 602, information representing one or more hands (e.g., codes or features representing an appearance of the hand(s), a pose of the hand(s), or other information) of the user of the client device 602, pose information (e.g., a pose in six-degrees-of-freedom (6-DOF), referred to as a 6-DOF pose) of the client device 602, audio associated with an environment in which the client device 602 is located, any combination thereof, and/or other information. Similar information can be provided from the client device 604 and the client device 606.

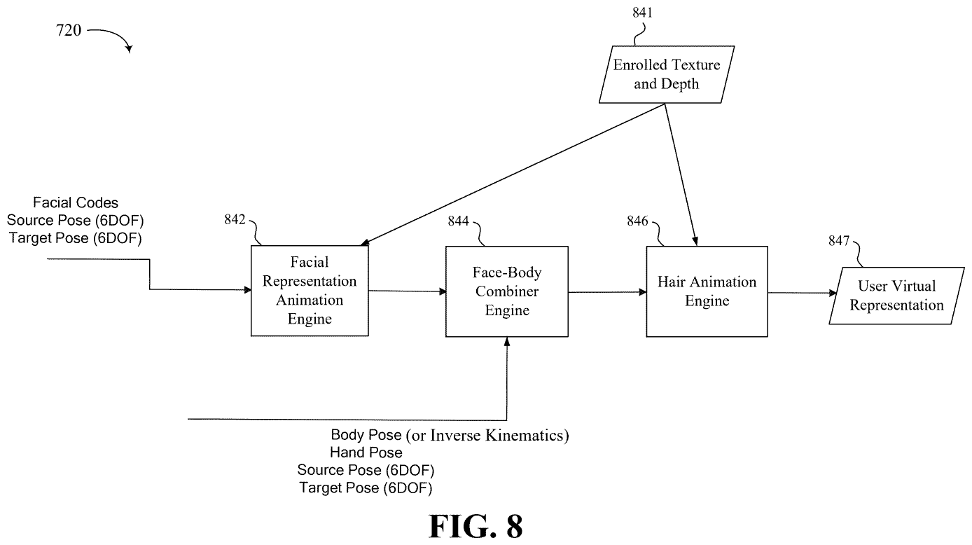

The user virtual representation system 620 of the animation and scene rendering system 610 may process the information (e.g., a facial representation, body representation, pose information, etc.) provided from each of the client devices 602, 604, 606 and can generate and/or animate a virtual representation (or avatar) for each respective user of the client devices 602, 604, 606. As used herein, animation of a virtual representation (or avatar) of a user refers to modifying a position, movement, mannerism, or other feature of the virtual representation so that the animation matches a corresponding position, movement, mannerism, etc. of the corresponding user in a real-world environment or space. In some aspects, as described in more detail below with respect to FIG. 8, to generate and/or animate the virtual representation for the first user, the user virtual representation system 620 may generate and/or animate a virtual representation of a face of the user (a facial representation) of the client device 602, generate and/or animate a virtual representation of a body (a body representation) of the user of the client device 602, and generate and/or animate a virtual representation of hair (a hair representation) of the user of the client device 602. In some cases, the user virtual representation system 620 may combine or attach the facial representation with the body representation to generate a combined virtual representation. The user virtual representation system 620 may then add the hair representation to the combined virtual representation to generate a final virtual representation of the user for one or more frames of content (shown in FIG. 6 as virtual content frames). The scene rendering system can transmit the one or more frames to the client devices 602, 604, 606.

A scene composition system 622 of the animation and scene rendering system 610 may then compose a virtual scene or environment for the virtual session and generate a respective target view (e.g., a frame of content, such as virtual content or a combination of real-world and virtual content) for each of the client devices 602, 604, 606 from a respective perspective of each device or user in the virtual scene or environment. The virtual scene composed by the scene composition system 622 includes the virtual representations of the users involved in the virtual session and any virtual background of the scene. In one example, using the information received from the other client devices 604, 606, the scene composition system 622 may compose the virtual scene (including virtual representations of the users and background information) and generate a frame representing a view of the virtual scene from the perspective of the user of the client device 602.

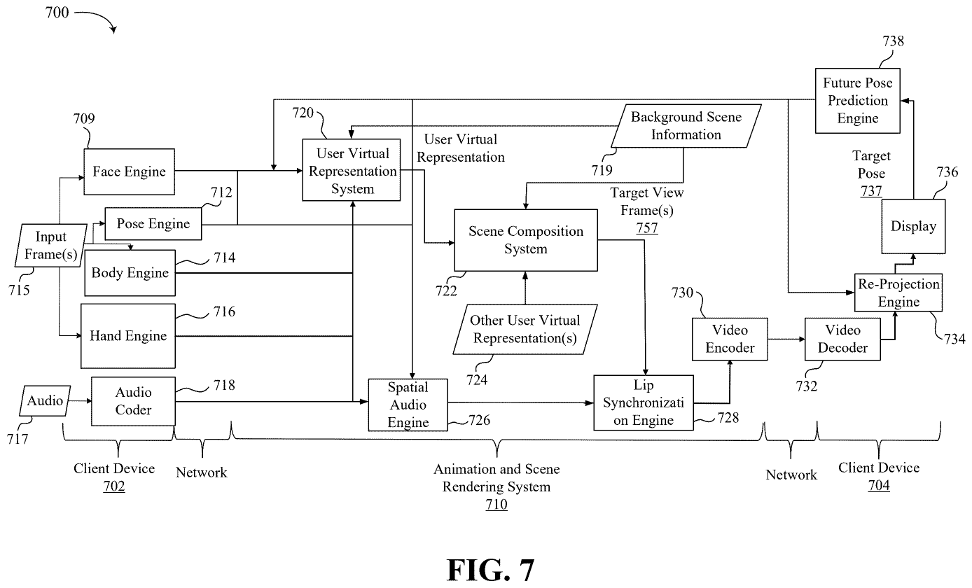

FIG. 7 is a diagram illustrating an example of an XR system 700 configured to perform aspects described herein including, but not limited to, an efficient communication framework for virtual representation calls for the virtual environment by performing, or using, split or hybrid rendering, gradual transitioning of rendering, a mixed-rendering session, a voice-only session start, a progressive or partial download, and/or pre-loaded avatar base models, as described herein. The XR system 700 system includes a client device 702 and a client device 704 participating in a virtual session (in some cases with other client devices not shown in FIG. 7). The client device 702 may send information to an animation and scene rendering system 710 via a network (e.g., a real-time communications (RTC) network or another wireless network). The animation and scene rendering system 710 can generate frames for a virtual scene from the perspective of a user of the client device 704 and can transmit the frames or images (referred to as a target view frame or image) to the client device 704 via the network. The client device 702 may include a first XR device (e.g., a virtual reality (VR) head-mounted display (HMD), augmented reality (AR) or mixed (MR) glasses, etc.) and the client device 704 may include a second XR device.

The frames transmitted to the client device 704 include a view of the virtual scene from a perspective of a user of the client device 704 (e.g., the user can view virtual representations of other users in the virtual scene as if the users are in a physical space together) based on a relative difference between the pose of the client device 704 and each respective pose of the client device 702 and any other devices providing information to the animation and scene rendering system 710. In the example of FIG. 7, the client device 702 can be considered a source (e.g., a source of information for generating at least one frame for the virtual scene) and the client device 704 can be considered a target (e.g., a target for receiving the at least one frame generated for the virtual scene).

As noted above, the information sent by a client device to an animation and scene rendering system (e.g., from client device 702 to animation and scene rendering system 710) may include information representing a face (e.g., codes or features representing an appearance of the face or other information) of a user of the client device 702, information representing a body (e.g., codes or features representing an appearance of the body, a pose of the body, or other information) of the user of the client device 702, information representing one or more hands (e.g., codes or features representing an appearance of the hand(s), a pose of the hand(s), or other information) of the user of the client device 702, pose information (e.g., a pose in six-degrees-of-freedom (6-DOF), referred to as a 6-DOF pose) of the client device 702, audio associated with an environment in which the client device 702 is located, any combination thereof, and/or other information.

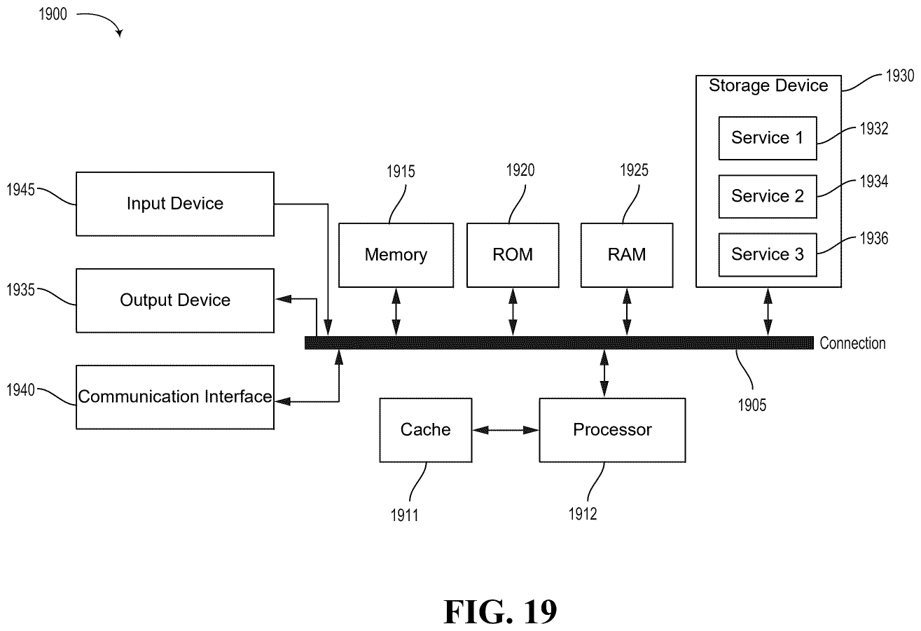

For example, the computing device 702 may include a face engine 709, a pose engine 712, a body engine 714, a hand engine 716, and an audio coder 718. In some aspects, the computing device 702 may include a body engine configured to generate a virtual representation of the user's body. The computing device 702 may include other components or engines other than those shown in FIG. 7 (e.g., one or more components on the device 500 of FIG. 5, one or more components of the computing system 1900 of FIG. 19, etc.). The computing device 704 is shown to include a video decoder 732, a re-projection engine 734, a display 736, and a future pose prediction engine 738. In some cases, each client device (e.g., client device 702, client device 702, client device 602 of FIG. 6, client device 604 of FIG. 6, client device 606 of FIG. 6, etc.) may include a face engine, a pose engine, a body engine, a hand engine, an audio coder (and in some cases an audio decoder or combined audio encoder-decoder), a video decoder (and in some cases a video encoder or combined video encoder-decoder), a re-projection engine, a display, and a future pose prediction engine. These engines or components are not shown in FIG. 7 with respect to the client device 702 and the client device 704 because the client device 702 is a source device and the client device 704 is a target device in the example of FIG. 7.

The face engine 709 of the client device 702 may receive one or more input frames 715 from one or more cameras of the client device 702. For instance, the input frame(s) 715 received by the face engine 709 may include frames (or images) captured by one or more cameras with a field of view of a mouth of the user of the client device 702, a left eye of the user, and a right eye of the user. Other images may also be processed by the face engine 709. In some cases, the input frame(s) 715 can be included in a sequence of frames (e.g., a video, a sequence of standalone or still images, etc.). The face engine 709 can generate and output a code (e.g., a feature vector or multiple feature vectors) representing a face of the user of the client device 702. The face engine 709 can transmit the code representing the face of the user to the animation and scene rendering system 710. In one illustrative example, the face engine 709 may include one or more face encoders that include one or more machine learning systems (e.g., a deep learning network, such as a deep neural network) trained to represent faces of users with a code or feature vector(s). In some cases, the face engine 709 can include a separate encoder for each type of image that the face engine 709 processes, such as a first encoder for frames or images of the mouth, a second encoder for frames or images of the right eye, and a third encoder for frames or images of the left eye. The training can include supervised learning (e.g., using labeled images and one or more loss functions, such as mean-squared error MSE), semi-supervised learning, unsupervised learning, etc.). For instance, a deep neural network may generate and output the code (e.g., a feature vector or multiple feature vectors) representing the face of the user of the client device 702. The code can be a latent code (or bitstream) that can be decoded by a face decoder (not shown) of the animation and scene rendering system 710 that is trained to decode codes (or feature vector) representing faces of users in order to generate virtual representations of the faces (e.g., a face mesh). For example, the face decoder of the animation and scene rendering system 710 can decode the code received from the client device 702 to generate a virtual representation of the user's face.

The pose engine 712 can determine a pose (e.g., 6-DOF pose) of the client device 702 (and thus the head pose of the user of the client device 702) in the 3D environment. The 6-DOF pose can be an absolute pose. In some cases, the pose engine 712 may include a 6-DOF tracker that can track three degrees of rotational data (e.g., including pitch, roll, and yaw) and three degrees of translation data (e.g., a horizontal displacement, a vertical displacement, and depth displacement relative to a reference point). The pose engine 712 (e.g., the 6-DOF tracker) may receive sensor data as input from one or more sensors. In some cases, the pose engine 712 includes the one or more sensors. In some examples, the one or more sensors may include one or more inertial measurement units (IMUs) (e.g., accelerometers, gyroscopes, etc.), and the sensor data may include IMU samples from the one or more IMUs. The pose engine 712 can determine raw pose data based on the sensor data. The raw pose data may include 6DOF data representing the pose of the client device 702, such as three-dimensional rotational data (e.g., including pitch, roll, and yaw) and three-dimensional translation data (e.g., a horizontal displacement, a vertical displacement, and depth displacement relative to a reference point).

The body engine 714 may receive one or more input frames 715 from one or more cameras of the client device 702. The frames received by the body engine 714 and the camera(s) used to capture the frames may be the same or different from the frame(s) received by the face engine 709 and the camera(s) used to capture those frames. For instance, the input frame(s) received by the body engine 714 may include frames (or images) captured by one or more cameras with a field of view of body (e.g., a portion other than the face, such as a neck, shoulders, torso, lower body, feet, of the user etc.) of the user of the client device 702. The body engine 714 can perform one or more techniques to output a representation of the body of the user of the client device 702. In one example, the body engine 714 can generate and output a 3D mesh (e.g., including a plurality of vertices, edges, and/or faces in 3D space) representing a shape of the body. In another example, the body engine 714 can generate and output a code (e.g., a feature vector or multiple feature vectors) representing a body of the user of the client device 702. In one illustrative example, the body engine 714 may include one or more body encoders that include one or more machine learning systems (e.g., a deep learning network, such as a deep neural network) trained to represent bodies of users with a code or feature vector(s). The training can include supervised learning (e.g., using labeled images and one or more loss functions, such as MSE), semi-supervised learning, unsupervised learning, etc.). For instance, a deep neural network may generate and output the code (e.g., a feature vector or multiple feature vectors) representing the body of the user of the client device 702. The code can be a latent code (or bitstream) that can be decoded by a body decoder (not shown) of the animation and scene rendering system 710 that is trained to decode codes (or feature vectors) representing virtual bodies of users in order to generate virtual representations of the bodies (e.g., a body mesh). For example, the body decoder of the animation and scene rendering system 710 can decode the code received from the client device 702 to generate a virtual representation of the user's body.

The hand engine 716 may receive one or more input frames 715 from one or more cameras of the client device 702. The frames received by the hand engine 716 and the camera(s) used to capture the frames may be the same or different from the frame(s) received by the face engine 709 and/or the body engine 714 and the camera(s) used to capture those frames. For instance, the input frame(s) received by the hand engine 716 may include frames (or images) captured by one or more cameras with a field of view of hands of the user of the client device 702. The hand engine 716 can perform one or more techniques to output a representation of the one or more hands of the user of the client device 702. In one example, the hand engine 716 can generate and output a 3D mesh (e.g., including a plurality of vertices, edges, and/or faces in 3D space) representing a shape of the hand(s). In another example, the hand engine 716 can output a code (e.g., a feature vector or multiple feature vectors) representing the one or more hands. For instance, the hand engine 716 may include one or more body encoders that include one or more machine learning systems (e.g., a deep learning network, such as a deep neural network) that are trained (e.g., using supervised learning, semi-supervised learning, unsupervised learning, etc.) to represent hands of users with a code or feature vector(s). The code can be a latent code (or bitstream) that can be decoded by a hand decoder (not shown) of the animation and scene rendering system 710 that is trained to decode codes (or feature vectors) representing virtual hands of users in order to generate virtual representations of the bodies (e.g., a body mesh). For example, the hand decoder of the animation and scene rendering system 710 can decode the code received from the client device 702 to generate a virtual representation of the user's hands (or one hand in some cases).

The audio coder 718 (e.g., audio encoder or combined audio encoder-decoder) can receive audio data 717, such as audio obtained using one or more microphones of the client device 702. The audio coder 718 can encode or compress audio data and transmit the encoded audio to the animation and scene rendering system 710. The audio coder 718 can perform any type of audio coding to compress the audio data, such as a Modified discrete cosine transform (MDCT) based encoding technique. The encoded audio can be decoded by an audio decoder (not shown) of the animation and scene rendering system 710 that is configured to perform an inverse process of the audio encoding process performed by the audio coder 718 to obtain decoded (or decompressed) audio.

A user virtual representation system 720 of the animation and scene rendering system 710 can receive the input information received from the client device 702 and use the input information to generate and/or animate a virtual representation (or avatar) of the user of the client device 702. In some aspects, the user virtual representation system 720 may also use a future predicted pose of the client device 704 to generate and/or animate the virtual representation of the user of the client device 702. In such aspects, the future pose prediction engine 738 of the client device 704 may predict pose of the client device 704 (e.g., corresponding to a predicted head pose, body pose, hand pose, etc. of the user) based on a target pose (e.g., target pose 737) and transmit the predicted pose to the user virtual representation system 720. For instance, the future pose prediction engine 738 may predict the future pose of the client device 704 (e.g., corresponding to head position, head orientation, a line of sight such as view 130-A or 130-B of FIG. 1, etc. of the user of the client device 704) for a future time (e.g., a time T, which may be the prediction time) according to a model. The future time T can correspond to a time when a target view frame (e.g., target view frame 757) will be output or displayed by the client device 704. As used herein, reference to a pose of a client device (e.g., client device 704) and to a head pose, body pose, etc. of a user of the client device can be used interchangeably.

The predicted pose can be useful when generating a virtual representation because, in some cases, virtual objects may appear delayed to a user when compared to an expected view of the objects to the user or compared with real-world objects that the user is viewing (e.g., in an AR, MR, or VR see-through scenario). Referring to FIG. 1 as an illustrative example, without head motion or pose prediction, updating of virtual objects in view 130-B from the previous view 130-A may be delayed until head pose measurements are conducted such that the position, orientation, sizing, etc. of the virtual objects may be updated accordingly. In some cases, the delay may be due to system latency (e.g., end-to-end system delay between client device 704 and a system or device rendering the virtual content, such as the animation and scene rendering system 710), which may be caused by rendering, time warping, or both. In some cases, such delay may be referred to as round trip latency or dynamic registration error. In some cases, the error may be large enough that the user of client device 704 may perform a head motion (e.g., the head motion 115 illustrated in FIG. 1) before a time pose measurement may be ready for display. Thus, it may be beneficial to predict the head motion 115 such that virtual objects associated with the view 130-B can be determined and updated in real-time based on the prediction (e.g., patterns) in the head motion 115.

As noted above, the user virtual representation system 720 may use the input information received from the client device 702 and the future predicted pose information from the future pose prediction engine 738 to generate and/or animate the virtual representation of the user of the client device 702. As noted herein, animation of the virtual representation of the user can include modifying a position, movement, mannerism, or other feature of the virtual representation to match a corresponding position, movement, mannerism, etc. of the user in a real-world or physical space. An example of the user virtual representation system 720 is described below with respect to FIG. 8. In some aspects, the user virtual representation system 720 may be implemented as a deep learning network, such as a neural network (e.g., a convolutional neural network (CNN), an autoencoder, or other type of neural network) trained based on input training data (e.g., codes representing faces of users, codes representing bodies of users, codes representing hands of users, pose information such as 6-DOF pose information of client devices of the users, inverse kinematics information, etc.) using supervised learning, semi-supervised learning, unsupervised learning, etc. to generate and/or animate virtual representations of users of client devices.

FIG. 8 is a diagram illustrating an illustrative example of the user virtual representation system 720. A facial representation animation engine 842 of the user virtual representation system 720 can generate and/or animate a virtual representation of a face (or the entire head) of the first user (referred to as a facial representation) of the client device 702. The facial representation can include a 3D mesh (including a plurality of vertices, edges, and/or faces in 3D space) representing a shape of the face or head of the user of the client device 702 and texture information representing features of the face.

As shown in FIG. 8, the facial representation animation engine 842 can obtain (e.g., receive, retrieve, etc.) the facial codes (e.g., a feature vector or multiple feature vectors) output from the face engine 709, a source pose of the client device 702 (e.g., the 6-DOF pose output by the pose engine 712), and a target pose (e.g., target pose 737) of the client device 704 (e.g., a 6-DOF pose output by a pose engine of the client device 704 and received by the animation and scene rendering system 710). The facial representation animation engine 842 can also obtain texture information (e.g., color and surface detail of the face) and depth information (shown as enrolled texture and depth information 841). The texture information and depth information may be obtained during an enrollment stage, where a user uses one or more cameras of a client device (e.g., the client device 702, 704, etc.) to capture one or more images of the user. The images can be processed to determine the text and depth information of the user's face (and in some cases the user's body and/or hair). Using the facial codes, the source and target poses, and the enrolled texture and depth information 841, the facial representation animation engine 842 can generate (or animate) the face of the user of the client device 702 in a pose from a perspective of the user of the client device 704 (e.g., based on a relative difference between the pose of the client device 704 and each respective pose of the client device 702 and any other devices providing information to the animation and scene rendering system 710) and with facial features that correspond to the features of the face of the user. For example, the facial representation animation engine 842 may compute a mapping based on the facial codes, the source and target poses, and the enrolled texture and depth information 841. The mapping may be learned using offline training data (e.g., using supervised training, unsupervised training, semi-supervised training, etc.). The facial representation animation engine 842 can use the mapping to determine how the animation of the face of the user should appear based on the input and enrolled data.

A face-body combiner engine 844 of the user virtual representation system 720 can obtain, generate, and/or animate a virtual representation of a body (referred to as a body representation) of the user of the client device 702. For example, as shown in FIG. 8, the face-body combiner engine 844 can obtain a pose of the one or more hands of the user of the client device 702 output by the hand engine 716, the source pose of the client device 702, and the target pose of the client device 704. In some aspects, the face-body combiner engine 844 may also obtain a pose of the body of the user of the client device 702 output by the body engine 714. In other aspects, the pose of the body may be estimated using inverse kinematics. For example, using the head pose (e.g., a 6DOF head pose or device pose) from the pose engine 712 and the hand pose from the hand engine 716, the face-body combiner engine 844 can estimate joint parameters of the user's body to manipulate the body, arms, legs, etc. The face-body combiner engine 844 can estimate the joint parameters using any suitable kinematics equation (e.g., an inverse kinematics equation or set of equations, such as a Forward And Backward Reaching Inverse Kinematics (FABRIK) heurist method). Using the pose of the hand(s), the source and target poses, and either the body pose or a result of the inverse kinematics, the face-body combiner engine 844 can determine a pose of the body of the user of the client device 702 from a perspective of the user of the client device 704 (e.g., based on a relative difference between the pose of the client device 704 and each respective pose of the client device 702 and any other devices providing information to the animation and scene rendering system 710).

The face-body combiner engine 844 can combine or attach the facial representation with the body representation to generate a combined virtual representation. For instance, as noted above, the facial representation may include a 3D mesh of the face or head of the user of the client device 702 and texture information representing features of the face. The body representation may include a 3D mesh of the body of the user of the client device 702 and texture information representing features of the body. The face-body combiner engine 844 can combine or merge the previously-synthesized 3D mesh of the facial representation (or full head) with the 3D mesh of the body representation (including the one or more hands) to generate the combined virtual representation (e.g., a combined 3D mesh of the face/head and body). In some cases, the 3D mesh of the body representation may be a generic 3D mesh of a male or female (corresponding to whether the user is male or female). In one example, the vertices of the face/head 3D mesh and the body 3D mesh that correspond to the user's neck are merged (e.g., joined together) to make a seamless transition between the face/head and the body of the user. After combining or merging the 3D mesh of the facial representation/head with the 3D mesh of the body representation, the two 3D meshes will be one joint 3D mesh. The face-body combiner engine 844 may then ensure that the skin color of the body mesh matches the skin diffuse color (e.g., albedo) and the other materials of the face/head mesh. For instance, the face-body combiner engine 844 may estimate the skin parameters of the head and may transfer the skin parameters to the skin of the body. In one illustrative example, the face-body combiner engine 844 may use a transfer map (e.g., provided by Autodesk™) to transfer a diffuse map representing the diffuse color of the face/head mesh to the body mesh.

A hair animation engine 846 of the user virtual representation system 720 can generate and/or animate a virtual representation of hair (referred to as a hair representation) of the user of the client device 702. The hair representation can include a 3D mesh (including a plurality of vertices, edges, and/or faces in 3D space) representing a shape of the hair and texture information representing features of the hair. The hair animation engine 846 can perform the hair animation using any suitable technique. In one example, the hair animation engine 846 may obtain or receive a reference 3D Mesh based on hair cards or strands that can be animated based on motion of the head. In another example, the hair animation engine 846 may perform an image inpainting technique by adding color on the 2D image output of the virtual representation (or avatar) of the user (output by the user virtual representation system 720) based on the motion or pose of the head and/or body. One illustrative example of an algorithm that may be used by the hair animation engine 846 to generate and/or animate a virtual representation of the user's hair includes Multi-input Conditioned Hair Image generative adversarial networks (GAN) (MichiGAN).

In some aspects, the facial representation animation engine 842 can also obtain the enrolled texture and depth information 841, which may include text and depth information of the hair of the user of the client device 702. The animation and scene rendering system 720 may then combine or add the hair representation to the combined virtual representation to generate a final user virtual representation 847 of the user of the client device 702. For example, the animation and scene rendering system 720 can combine the combined 3D mesh (including the combination of the face mesh and the body mesh including the one or more hands) with the 3D mesh of the hair to generate the final user virtual representation 847.

Returning the FIG. 7, the user virtual representation system 720 may output the virtual representation of the user of the client device 702 to a scene composition system 722 of the animation and scene rendering system 710. Background scene information 719 and other user virtual representations 724 of other users participating in the virtual session (if any exist) are also provided to the scene composition system 722. The background scene information 719 can include lighting of the virtual scene, virtual objects in the scene (e.g., virtual buildings, virtual streets, virtual animals, etc.), and/or other details related to the virtual scene (e.g., a sky, clouds, etc.). In some cases, such as in an AR, MR, or VR see-through setting (where video frames of a real-world environment are displayed to a user), the lighting information can include lighting of a real-world environment in which the client device 702 and/or the client device 704 (and/or other client devices participating in the virtual session) are located. In some cases, the future predicted pose from the future pose prediction engine 738 of the client device 704 may also be input to the scene composition system 722.

Using the virtual representation of the user of the client device 702, the background scene information 719, and virtual representations of other users (if any exist) (and in some cases the future predicted pose), the scene composition system 722 can compose target view frames for the virtual scene with a view of the virtual scene from the perspective of the user of the client device 704 based on a relative difference between the pose of the client device 704 and each respective pose of the client device 702 and any other client devices of users participating in the virtual session. For example, a composed target view frame can include a blending of the virtual representation of the user of the client device 702, the background scene information 719 (e.g., lighting, background objects, sky, etc.), and virtual representations of other users that may be involved in the virtual session. The poses of virtual representations of any other users are also based on a pose of the client device 704 (corresponding to a pose of the user of the client device 704).

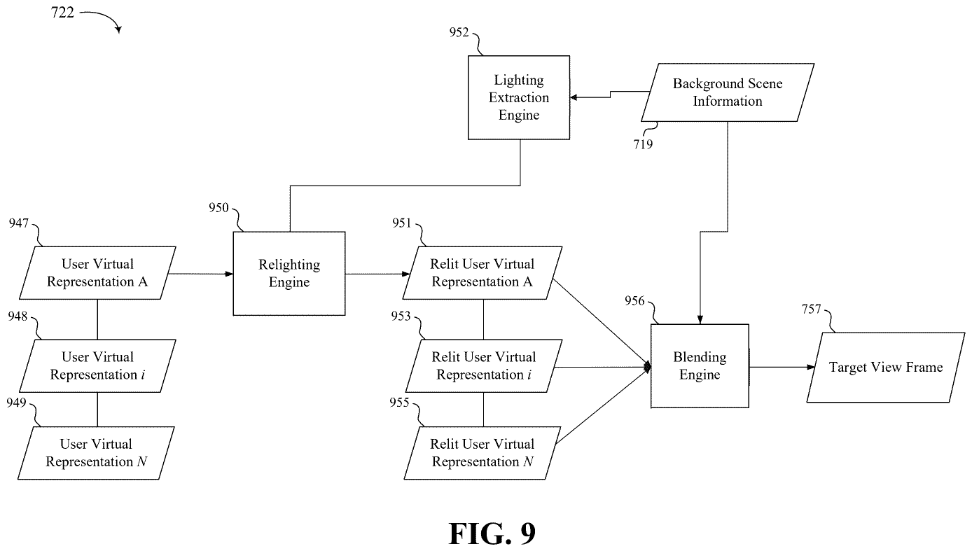

FIG. 9 is a diagram illustrating an example of the scene composition system 722. As noted above, the background scene information 719 may include lighting information of the virtual scene (or lighting information of a real-world environment in some cases). A lighting extraction engine 952 of the scene composition system 722 can obtain the background scene information 719 and extract or determine the lighting information of the virtual scene (or real-world scene) from the background scene information 719. For example, a high dynamic range (HDR) map (e.g., a high dynamic range image (HDRI) map including a 360-degrees image) of a scene may be captured by rotating a camera around the scene in a plurality of directions (e.g., in all directions), in some cases from a single viewpoint. The HDR map or image maps the lighting characteristics of the scene by storing the real world values of light and reflections at each location in the scene. The scene composition system 722 can then extract the light from the HDR map or image (e.g., using one or more convolution kernels).

The lighting extraction engine 952 can output the extracted lighting information to a relighting engine 950 of the scene composition system 722. When generating a target view image of the virtual scene, the relighting engine 950 may use the lighting information extracted from the background scene information 719 to perform relighting of a user virtual representation A 947, a user virtual representation i 948, through a user virtual representation N 949 (where there are N total user virtual representations, with N being greater than or equal to 0) representing users participating in the virtual session. The user virtual representation A 947 can represent the user of the client device 702 of FIG. 7 and the user virtual representation i 948 through the user virtual representation N 949 can represent one or more other users participating in the virtual session. The relighting engine 950 can modify the lighting of the virtual representations A 947, the user virtual representation i 948, through the user virtual representation N 949 so that the virtual representations appear as realistic as possible when viewed by the user of the client device 704. A result of the relighting performed by the relighting engine 950 includes a relit user virtual representations A 951, a relit user virtual representation i 953, through a relit user virtual representation N 955.

In some examples, the relighting engine 950 may include one or more neural networks that are trained (e.g., using supervised training, unsupervised training, semi-supervised training, etc.) to relight the foreground (and in some cases the background) of the virtual scene using extracted light information. For instance, the relighting engine 950 may segment the foreground (e.g., the user) from one or more images of the scene and may estimate a geometry and/or normal map of the user. The relighting engine 950 may use the normal map and the lighting information (e.g., the HDRI map or the current environment of the user) from the lighting extraction engine 952 to estimate an Albedo map including albedo information of the user. The relighting engine 950 may then use the albedo information along with the lighting information (e.g., the HDRI map) from the lighting extraction engine 952 to relight the scene. In some cases, the relighting engine 950 may use techniques other than machine learning.

A blending engine 956 of the scene composition system 722 can blend the relit user virtual representations 951, 953, and 955 into the background scene represented by the background scene information 719 to generate the target view frame 757. In one illustrative example, the blending engine 956 may apply Poisson image blending (e.g., using image gradients) to blend the relit user virtual representations 951, 953, and 955 into the background scene. In another illustrative example, the blending engine 956 may include one or more neural networks trained (e.g., using supervised training, unsupervised training, semi-supervised training, etc.) to blend the relit user virtual representations 951, 953, and 955 into the background scene.

Returning the FIG. 7, a spatial audio engine 726 may receive as input the encoded audio generated by the audio coder 718 and in some cases the future predicted pose information from the future pose prediction engine 738. Using the inputs to generate audio that is spatially oriented according to the pose of the user of the client device 704. A lip synchronization engine 728 can synchronize the animation of the lips of the virtual representation of the user of the client device 702 depicted in the target view frame 757 with the spatial audio output by the spatial audio engine 726. The target view frame 757 (after synchronization by the lip synchronization engine 728) may be output to a video encoder 730. The video encoder 730 can encode (or compress) the target view frame 757 using a video coding technique (e.g., according to any suitable video codec, such as advanced video coding (AVC), high efficiency video coding (HEVC), versatile video coding (VVC), moving picture experts group (MPEG), etc.). The animation and scene rendering system 710 can then transmit the target view frame 757 to the client device 704 via the network.

A video decoder 732 of the client device 704 can decode the encoded target view frame 757 using an inverse of the video coding technique performed by the video encoder 730 (e.g., according to a video codec, such as AVC, HEVC, VVC, etc.). A re-projection engine 734 can perform re-projection to re-project the virtual content of the decoded target view frame according to the predicted pose determined by the future pose prediction engine 738. The re-projected target view frame can then be displayed on a display 736 so that the user of the client device 704 can view the virtual scene from that user's perspective.

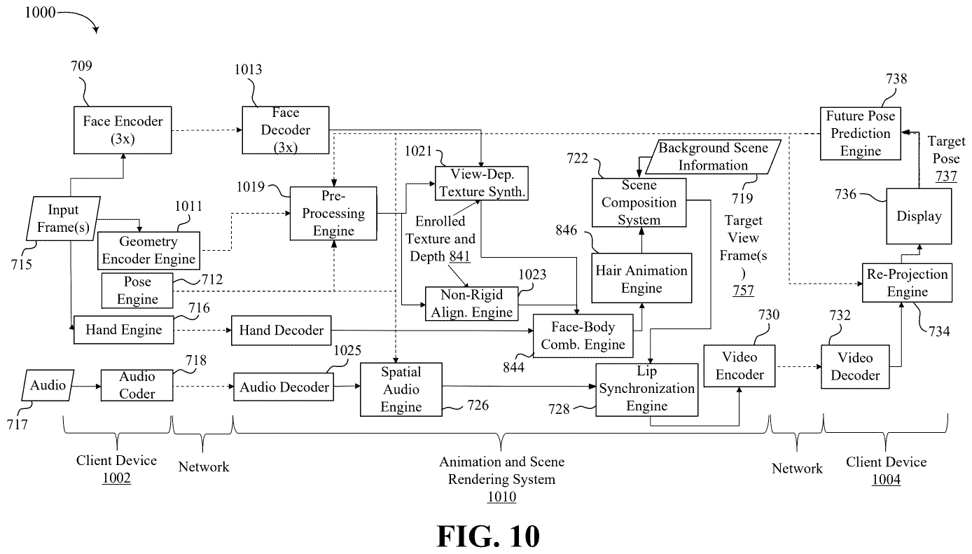

FIG. 10 illustrates another example of an XR system 1000 configured to perform aspects described herein. As shown in FIG. 10, the XR system 1000 includes some of the same components (with like numerals) as the XR system 700 of FIG. 7 and also includes additional or alternative components as compared to the XR system 700. The face engine 709, the pose engine 712, the hand engine 716, the audio coder 718, the spatial audio engine 726, the scene composition system 722, the lip synchronization engine 728, the video encoder, the video decoder, the re-projection engine 734, the display 736, and the future pose projection engine 738 are configured to perform the same or similar operations as the same components of the XR system 700 of FIG. 7. In some aspects, the XR system 1000 may include a body engine configured to generate a virtual representation of the user's body. Similarly, the face-body combiner engine 844 and the hair animation engine 846 are configured to perform the same or similar operations as the same components of FIG. 8.

Similar to the XR system 700 of FIG. 7, the XR system 1000 system includes a client device 1002 and a client device 1004 participating in a virtual session (in some cases with other client devices not shown in FIG. 10). The client device 1002 may send information to an animation and scene rendering system 1010 via a network (e.g., a real-time communications (RTC) network or other type of wireless network). The animation and scene rendering system 1010 can generate target view frames for a virtual scene from the perspective of a user of the client device 1004 and can transmit the target view frames to the client device 1004 via the network. The client device 1002 may include a first XR device (e.g., a VR HMD, AR, or MR glasses, etc.) and the client device 1004 may include a second XR device. The animation and scene rendering system 1010 is shown to include an audio decoder 1025 that is configured to decode an audio bitstream received from the audio coder 718.

The face engine is shown as a face engine 709 in FIG. 10. The face engine 709 of the client device 1002 may receive one or more input frames 715 from one or more cameras of the client device 1002. In some examples, the input frame(s) 715 received by the face engine 709 may include frames (or images) captured by one or more cameras with a field of view of a mouth of the user of the client device 1002, a left eye of the user, and a right eye of the user. The face engine 709 can generate and output a code (e.g., a feature vector or multiple feature vectors) representing a face of the user of the client device 1002. The face engine 709 can transmit the code representing the face of the user to the animation and scene rendering system 1010. As noted above, the face engine 709 may include one or more machine learning systems (e.g., a deep learning network, such as a deep neural network) trained to represent faces of users with a code or feature vector(s). As indicated by the “3x” notation in FIG. 10, the face engine 709 may include a separate encoder (e.g., a separate encoder neural network) for each type of image that the face engine 709 processes, such as a first encoder for frames or images of a mouth of the user of the client device 1002, a second encoder for frames or images of a right eye of the user of the client device 1002, and a third encoder for frames or images of a left eye of the user of the client device 1002.

A face decoder 1013 of the animation and scene rendering system 1010 is trained to decode codes (or feature vector) representing faces of users in order to generate virtual representations of the faces (e.g., a face mesh). The face decoder 1013 may receive the code (e.g., a latent code or bitstream) from the face engine 709 and can decode the code received from the client device 1002 to generate a virtual representation of the user's face (e.g., a 3D mesh of the user's face). The virtual representation of the user's face can be output to a view-dependent texture synthesis engine 1021 of the animation and scene rendering system 1010, discussed below. In some cases, the view-dependent texture synthesis engine 1021 may be part of the user virtual representation system 720 described previously.

A geometry encoder engine 1011 of the client device 1002 may generate a 3D model (e.g., a 3D morphable model or 3DMM) of the user's head or face based on the one or more frames 715. In some aspects, the 3D model can include a representation of a facial expression in a frame from the one or more frames 715. In one illustrative example, the facial expression representation can be formed from blendshapes. Blendshapes can semantically represent movement of muscles or portions of facial features (e.g., opening/closing of the jaw, raising/lowering of an eyebrow, opening/closing eyes, etc.). In some cases, each blendshape can be represented by a blendshape coefficient paired with a corresponding blendshape vector. In some examples, the facial model can include a representation of the facial shape of the user in the frame. In some cases, the facial shape can be repsresented by a facial shape coefficient paired with a corresponding facial shape vector. In some implementations, the geometry encoder engine 1011 (e.g., a machine learning model) can be trained (e.g., during a training process) to enforce a consistent faical shape (e.g., consistent facial shape coefficients) for a 3D facial model regardless of a pose (e.g., pitch, yaw, and roll) associated with the 3D facial model. For example, when the 3D facial model is rendered into a 2D image or frame for display, the 3D facial model can be projected onto a 2D image or frame using a projection technique.

In some aspects, the blend shape coefficients may be further refined by additionally introducing a relative pose between the client device 1002 and the client device 1004. For instance, the relative pose information may be processed using a neural network to generate view-dependent 3DMM geometry that approximates ground truth geometry. In another example, the face geometry may be determined directly from the input frame(s) 715, such as by estimating additive vertices residual from the input frame(s) 715 and producing more accurate facial expression details for texture synthesis.

The 3D model of the user's head (or an encoded representation of the 3D model, such as a latent representation or feature vector representing the 3D model) can be output from the geometry encoder engine 1011 and received by a pre-processing engine 1019 of the animation and scene rendering system 1010. The pre-processing engine 1019 may also receive the future pose predicted by the future pose prediction engine 738 of the client device 1004 and the pose of the client device 1002 (e.g., 6-DOF poses) provided by the pose engine 712, as discussed above. The pre-processing engine 1019 can process the 3D model of the user's head and the poses of the client devices 1002, 1004 to generate a face of the user of the client device 1004 with a detailed facial expression in a particular pose (e.g., from the perspective of the pose the user of the client device 1004 relative to the pose of the user of the client device 1002). The pre-processing can be performed because, in some cases, the animation and scene rendering system 1010 is configured to modify a neutral face expression of the user of the client device 1002 (e.g., obtained as an enrolled neutral face offline by capturing an image or scan of the user's face) to animate the virtual representation (or avatar) of the user of the client device 1002 with different expressions under different viewpoints. To do this, the animation and scene rendering system 1010 may need to understand how to modify the neutral expression in order to animate the virtual representation of the user of the client device 1002 with the correct expression and pose. The pre-processing engine 1019 can encode the expression information provided by the geometry encoder engine 1011 (and in some cases the pose information provided by the pose engine 712, and/or the future pose information from the future pose prediction engine 738) so that the animation and scene rendering system 1010 (e.g., the view-dependent texture synthesis engine 1021 and/or non-rigid alignment engine 1023) can understand the expression and pose of the virtual representation of the user of the client device 1002 that is to be synthesized.

In one illustrative example, the 3D model (which may be a 3DMM as noted above) includes a position map defining a position of each point of the 3D model and normal information defining a normal of each point on the position map. The pre-processing engine 1019 can extend or convert the normal information and the position map into a coordinate UV space (which may be referred to as a UV face position map). In some cases, the UV face position map can provide and/or represent a 2D map of the face of the user of the client device 1004 captured in an input frame 715. For instance, the UV face position map can be a 2D image that records and/or maps the 3D positions of points (e.g., pixels) in UV space (e.g., 2D texture coordinate system). The U in the UV space and the V in the UV space can denote the axes of the UV face position map (e.g., the axes of a 2D texture of the face). In one illustrative example, the U in the UV space can denote a first axis (e.g., a horizontal X-axis) of the UV face position map and the V in the UV space can denote a second axis (e.g., a vertical Y-axis) of the UV face position map. In some examples, the UV position map can record, model, identify, represent, and/or calculate a 3D shape, structure, contour, depth, and/or other details of the face (and/or a face region of the head). In some implementations, a machine learning model (e.g., a neural network) can be used to generate the UV face position map.

The UV face position map can thus encode the expression of the face (and in some cases the pose of the head), providing information that can be used by the animation and scene rendering system 1010 (e.g., the view-dependent texture synthesis engine 1021 and/or non-rigid alignment engine 1023) to animate a facial representation for the user of the client device 1002. The pre-processing engine 1019 can output the pre-processed 3D model of the user's head to the view-dependent texture synthesis engine 1021 and to a non-rigid alignment engine 1023. In some cases, the non-rigid alignment engine 1023 may be part of the user virtual representation system 720 described previously.

As noted above, the view-dependent texture synthesis engine 1021 receives virtual representation of the user's face (the facial representation) from the face decoder 1013 and the pre-processed 3D model information from the pre-processing engine 1019. The view-dependent texture synthesis engine 1021 can combine information associated with the 3D model of the user's head (output from the pre-processing engine 1019) with the facial representation of the user (output from the face decoder 1013) to generate a full head model with facial features for the user of the client device 1002. In some cases, the information associated with the 3D model of the user's head output from the pre-processing engine 1019 may include the UV face position map described previously. The view-dependent texture synthesis engine 1021 may also obtain the enrolled texture and depth information 841 discussed above with respect to FIG. 8. The view-dependent texture synthesis engine 1021 can add the texture and depth from the enrolled texture and depth information 841 to the full head model of the user of the client device 1002. In some cases, the view-dependent texture synthesis engine 1021 may include a deep learning network, such as a neural network (e.g., a convolutional neural network (CNN), an autoencoder, or other type of neural network). For instance, the view-dependent texture synthesis engine 1021 may be a neural network trained (e.g., using supervised learning, semi-supervised learning, unsupervised learning, etc.) to process a UV face position map (and in some cases face information such as the face information output by the face decoder 1013) to generate a full head models of users.

The non-rigid alignment engine 1023 can move the 3D model of the head of the user of the client device 1002 in a translational direction in order to ensure that the geometry and texture are aligned or overlapping, which can reduce gaps between the geometry and the texture. The face-body combiner engine 844 can then combine the body model (not shown in FIG. 10) and the facial representation output by the view-dependent texture synthesis engine 1021 to generate a combined virtual representation of the user of the client device 702. The hair animation engine 846 can generate a hair model, which can be combined with the combined virtual representation of the user to generate a final user virtual representation (e.g., final user virtual representation 847) of the user of the client device 1002. The scene composition system 722 can then generate the target view frame 757, process the target view frame 757 as discussed above, and transmit the target view frame 757 (e.g., after being encoded by the video encoder 730) to the client device 1004.

As discussed above with respect to FIG. 7, the video decoder 732 of the client device 1004 can decode the encoded target view frame 757 using an inverse of the video coding technique performed by the video encoder 730 (e.g., according to a video codec, such as AVC, HEVC, VVC, etc.). The re-projection engine 734 can perform re-projection to re-project the virtual content of the decoded target view frame according to the predicted pose determined by the future pose prediction engine 738. The re-projected target view frame can then be displayed on a display 736 so that the user of the client device 1004 can view the virtual scene from that user's perspective.

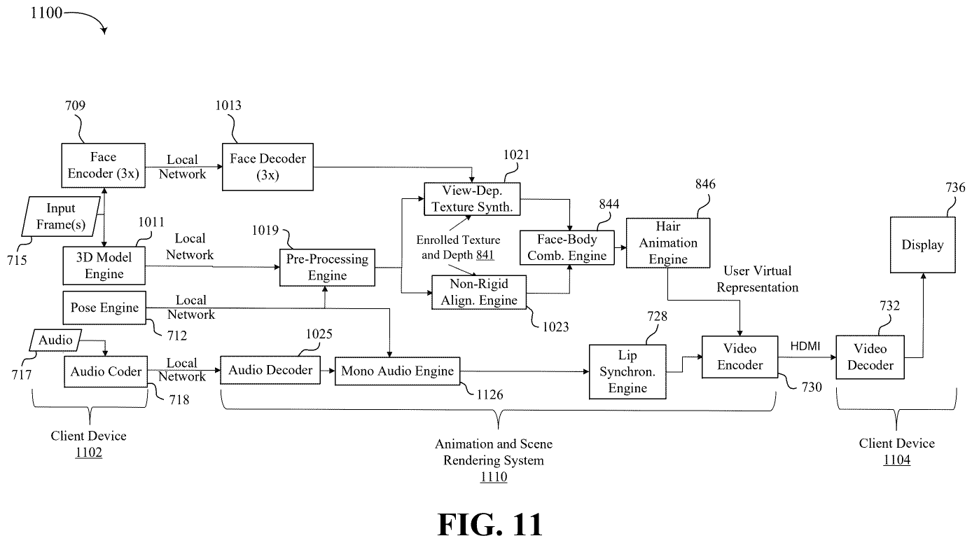

FIG. 11 illustrates another example of an XR system 1100 configured to perform aspects described herein. As shown in FIG. 11, the XR system 1100 includes some of the same components (with like numerals) as the XR system 700 of FIG. 7 and/or the XR system 1000 of FIG. 10 and also includes additional or alternative components as compared to the XR system 700 and the XR system 1000. The face engine 709, the face decoder 1013, the geometry encoder engine 1011, the pose engine 712, the pre-processing engine 1019, the view-dependent texture synthesis engine 1021, the non-rigid alignment engine 1023, the face-body combiner engine 844, the hair animation engine 846, the audio coder 718, and other like components are configured to perform the same or similar operations as the same components of the XR system 700 of FIG. 7 or the XR system 1000 of FIG. 10.

The XR system 1100 may be similar to the XR systems 700 and 1000 in that a client device 1102 and a client device 1104 participating in a virtual session (in some cases with other client devices not shown in FIG. 11). The XR system 1100 may be different from the XR systems 700 and 1000 in that the client device 1104 may be local to an animation and scene rendering system 1110. For instance, the client device 1104 may be communicatively connected to the animation and scene rendering system 1110 using a local connection, such as a wired connection (e.g., a high-definition multimedia interface (HDMI) cable, etc.). In one illustrative example, the client device 1104 may be a television, a computer monitor, or other device other than an XR device. In some cases, the client device 1104 (e.g., television, computer monitor, etc.) may be configured to display 3D content.

The client device 1102 may send information to the animation and scene rendering system 1110 via a network (e.g., a local network, RTC network, or another wireless network). The animation and scene rendering system 1110 can generate an animated virtual representation (or avatar) of a user of the client device 1102 for a virtual scene from the perspective of a user of the client device 1104 and can output the animated virtual representation to the client device 1104 via the local connection.

In some aspects, the animation and scene rendering system 1110 may include a mono audio engine 1126 instead of the spatial audio engine 726 of FIG. 7 and FIG. 10. In some cases, the animation and scene rendering system 1110 may include a spatial audio engine. In some cases, the animation and scene rendering system 1110 may include the spatial audio engine 726.

In some aspects, activity-driven per-blendshape enhancement with cumulative client caching is provided. For example, a network device (e.g., a media/rendering server) can transmit targeted enhancement information for blendshapes that are active at a given time (e.g., for only those blendshapes that are active at a given time, rather than pushing a full high-quality blendshape dictionary for all blendshapes). A first device (e.g., a client device) can apply the received enhancement to an in-progress frame and store (or persist) the enhancement data in a local storage (e.g., a cache or other type of storage). Over time, as additional blendshapes become active and their enhancements are received and stored (e.g., cached), the first device can incrementally bootstrap a high-detail avatar without an up-front bulk download.

The network device identifies, per rendering interval, a subset of active blendshapes whose weights exceed a threshold (e.g., a threshold denoted as &). For each such blendshape, the network device can obtain per-blendshape enhancement data, which can include one or more of geometry residuals (e.g., vertex deltas and connectivity updates that refine a low-detail blendshape mesh to a higher level of detail), texture residuals (e.g., per-region residuals and/or higher-resolution MIP levels for albedo/normal/specular tied to the specific blendshape region(s)), auxiliary parameters (e.g., updated skinning weights, micro-normal or displacement patches, shader coefficients, or compression parameters), any combination thereof, and/or other data.

In some cases, the network device can optionally schedule which enhancements to send based on activity frequency, anticipated re-use, bandwidth budget, priority policies, any combination thereof, and/or other factors, as described below.

In some aspects, upon receipt, the first device can apply the enhancement data to a corresponding low-detail blendshape (e.g. corresponding to the blendshape associated with the enhancement) currently being rendered so that a current frame reflects the higher detail and stores the enhancement in the local storage (e.g., cache, etc.) indexed by a blendshape identifier, body region, and/or level of detail (LoD). When the same blendshape becomes active at a later point in time, the first device can render at the enhanced quality without re-downloading the enhancement. In some cases, the storage can be bounded by size policies and may evict least-frequently-used entries first.

In some aspects, enhancement items may be packaged as ARF/ISOBMFF items with identifiers that cross-reference a (blendshapeID, regionID, LoD) tuple and may be fetched via HTTP byte-range requests. The enhancement may be losslessly or lossily coded; if lossy, the network device can provide refinement layers to reach higher quality levels as bandwidth permits. ISOBMFF corresponds with ISO Base Media File Format which is an international standard (ISO/IEC 14496-12) used as a container format for time-based multimedia data, such as video, audio, and images.

In some cases, enhancement items are encrypted at rest (e.g., when stored) and in transit (e.g., for transmission over a wireless network) and are scope-limited to a particular call/session or trust domain. For example, cached enhancements may be bound to a trusted contact graph or protected enclave, and may be invalidated or re-keyed upon user policy changes.

In some aspects, an activity-driven enhancement pipeline is provided. The activity-driven enhancement pipeline includes the client reporting currently active blendshapes (or the server derives them from motion/encoder streams), and the server selecting enhancement items. The client then applies enhancement to the current frame in addition to persisting the items in a local cache for future reuse.

An example process of the activity-driven enhancement pipeline performed by the first device can include the first device detecting active blendshapes with weights>ε. For each active blendshape, the process can include first device requesting (or pushing) per-blendshape enhancement, and applying enhancement to the current frame's low-LoD blendshape. The process can then include the first device storing (e.g., persisting) the enhancement and updating one or more cache indexes may be performed.

In some aspects, the system is deployed in a Third Generation Partnership Project (3GPP) IP Multimedia Subsystem (IMS) environment with a Media Function (MF) that performs server-side rendering and a Base Avatar Repository (BAR) that serves virtual representation (e.g., avatar) assets (e.g., ARF containers). The MF may provide 2D or 3D renderings while the first device downloads avatar information from the BAR. When the first device has downloaded sufficient avatar information to locally render a given user's avatar, server-side rendering for that user can cease. The completion indication can be conveyed via multiple variants such as a device-initiated indication (e.g., the first device sends a download complete (or LoD-X ready) message to the MF, which in response stops rendering that user's avatar and switching to sending animation parameters), a BAR-to-MF indication (e.g., the BAR notifies the MF that the client's download has completed (or reached a threshold LoD), which allows the MF to cease rendering), and/or co-location BAR/MF (e.g., when BAR and MF are co-located, the MF infers completion from local state such as repository logs, and transitions without an explicit external message.

In some aspects, the indication (such as the completion indication) may identify which participants are locally renderable and at which LoD (e.g., LoD1, LoD2, LoD3, etc.). The MF may continue to render some participants (e.g., participants not yet downloaded or beyond device capacity) while other participants are being rendered locally, consistent with the mixed-rendering aspects of the present disclosure.

In some aspects, a prioritization engine dynamically assigns target Levels of Detail (LoDs) to participants based on spatial and attentional cues, such as gaze direction, angular proximity to the user's fixation, distance within the scene, and conversational salience (e.g., active speaker). Participants nearer to the user's line-of-sight are upgraded to higher LoDs, while those in peripheral view are held at lower LoDs (e.g., stylized/cartoon) until attention shifts. As the user's attention changes, the system smoothly transitions LoDs to avoid popping artifacts.

Policy examples of the prioritization engine include gaze-centric (in which avatars within ±θ degrees of gaze receive LoD_high while other avatars receive LoD_low), distance-weighted (where LoD target ∝1/(1+d) where d is the estimated scene depth to the avatar), and bandwidth-aware (wherein the sum of requested enhancement bandwidths is budgeted, and extra capacity is applied to the most salient avatars), and/or conversational salience (e.g., active speaker). Participants at or near the user's fixation point receive higher-LoD assets, while peripheral participants render at lower LoD (e.g., stylized/cartoon), with smooth upgrades as attention shifts. Accordingly, an avatar directly across from the user and the current speaker are rendered at higher LoD, while distant peripheral avatars are rendered at lower LoD. As the user turns their head, LoD assignments re-prioritize accordingly.

In some aspects, the prioritization engine schedules which ARF segments (or per-blendshape enhancements) to fetch first so that near-gaze avatars gain quality fastest, while far avatars remain bandwidth-light until needed.

In some aspects, at session start, or under constrained bandwidth/compute, the MF can transmit 2D avatar frames (optionally accompanied by a per-pixel depth map). The first device decodes the frames and performs asynchronous time-warp (late-stage reprojection) using predicted head pose to align the panel to the user's instantaneous viewpoint. The panel mode provides immediate visual presence with low device load. As avatar assets progressively arrive, the client transitions to hybrid or fully local 3D rendering, disabling panel mode for that participant.

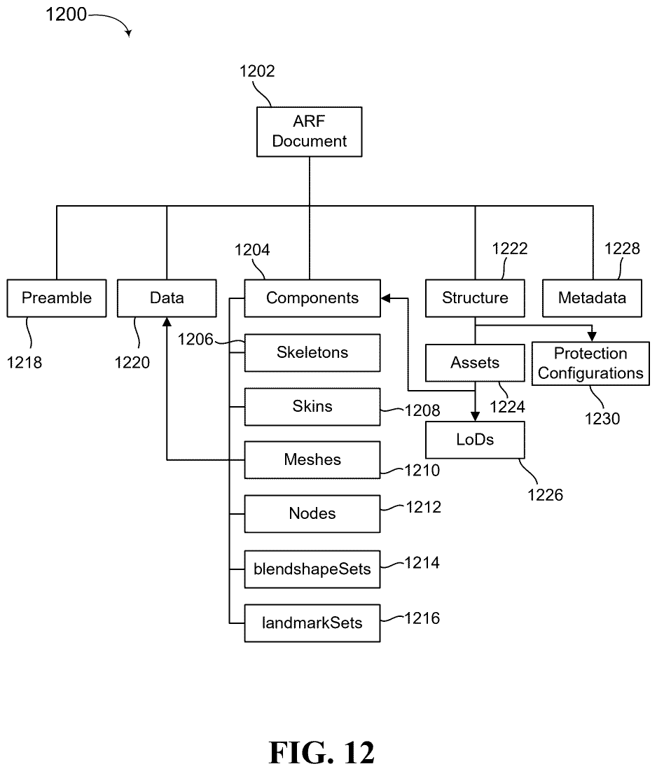

FIG. 12 illustrates an example Avatar Representation Format (ARF) 1200 according to aspects of the present disclosure. As shown in FIG. 12, the ARF is composed of an ARF document, an ARF container, and one or more animation streams. The ARF document provides description of components of a base avatar model. In some aspects, the description of the base avatar model components may be detailed description. The ARF container stores the ARF document and all assets and components corresponding to the ARF document. An animation stream of the one or more animation streams supports a format for blend shape and joint pose animation samples that are compatible with, for example, OpenXR.

FIG. 12 thus depicts an avatar modeling subsystem that converts captured user data into a structured geometric and texture-parameter representation, or a pipeline for generating, updating, and rendering a personalized human avatar within an extended-reality (XR) communication system. An ARF document 1202 is generated by ingesting captured facial, hair, and body data (e.g., data 1220) from sensors (e.g., cameras, depth sensors, head-mounted cameras), and processing the ingested data into avatar geometry including facial meshes, body meshes, hair volumes/surfaces, and generating (or updating) user-specific textures and material assets such as diffuse/albedo maps, normal maps, specular/roughness maps.

Sensor-based inputs feeding into the avatar modeling subsystem include video frames (e.g., RGB video frames) from HMD or external cameras, depth maps (e.g., structured-light, ToF, or stereo-derived), infrared or other specialized tracking data, and/or possibly voice or pose metadata.

Pre-processing and segmentation clean incoming frames, segments the face, hair, and upper body, and then normalize perspective and lighting. Additionally, depth may be extracted from stereo or infrared feeds. A geometry reconstruction or mesh generator generates the user's avatar mesh, for example, by executing machine learning models to estimate facial geometry, reconstructing head and neck topology, combining multi-view captures into a coherent mesh, producing a parametric or personalized mesh, and handling silhouette alignment and correcting imperfections.

Texture and material map creator creates albedo (diffuse) texture, normal map (surface details), and/or specular map (reflectivity/glossiness). The input to the texture and material map creator may be the multi-view images and the output may be texture-mapped assets coupled to the reconstructed geometry.

An avatar enrollment or template fitting engine may perform template fitting, calibration, identity parameter extraction, and/or persistent avatar profile creation to transform raw captures into a stable, reusable avatar model. A complete, personalized avatar package may thus include a mesh (or mesh family), material/texture sets, identity parameters, alignment and/or rigging data, and possibly blendshapes or 3DM coefficients.

The ARF document 1202 includes components 1204 (e.g., key components) of the avatar model, such as skeleton 1206 (e.g., hierarchy of joints and inverse bind matrices and linked to supported animation frameworks), skin 1208 (that binds a mesh 1210 to skeleton 1206 and includes weights, optional blendshape sets 1214, landmark sets 1216), mesh 1210 (e.g., geometry and topology references), blendshape set 1214 (e.g., facial shapes for expressions; indices compatible with mappings), landmark Set 1216 (e.g., vertex references for precise alignment and tracking), texture set (e.g., material textures to support target texture refinements), node 1212 (e.g., scene graph transform (TRS or 4×4 matrix), with optional parent/children), and mapping and LinearAssociation to map external animation parameters into ARF (weighted sums of sources).

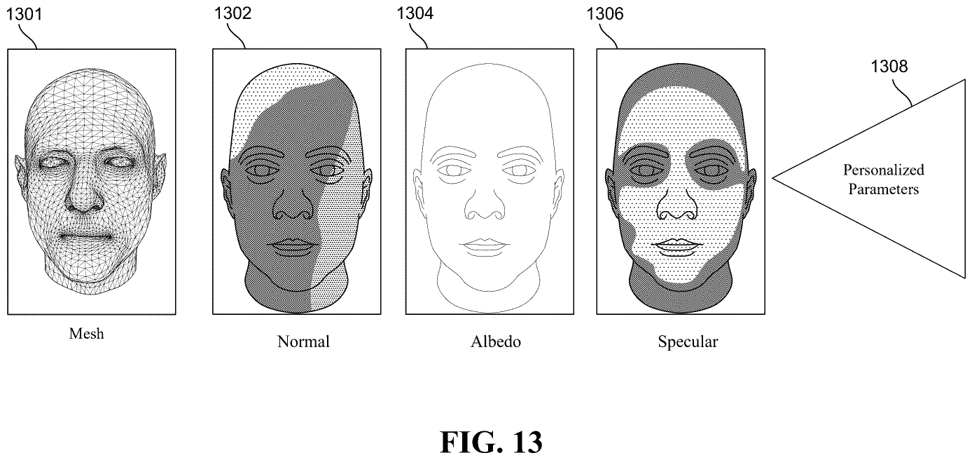

Structure 1222 corresponds to a hierarchical package, including assets 1224, LoDs 1226, and metadata 1228. Assets 1224 may include mesh and geometry; normal, albedo, specular textures, hair geometry and animation data, facial/body/hand animation rigs, user-specific parameters, and supporting metadata 1228, such as that described herein (e.g., with reference to FIG. 13). LoDs 1226 may include multiple level of detail for geometry (raw↔retopologized), textures, hair, and/or animation complexity).

Protection configurations 1230 provides protections for geometry, textures, animations, hair, asset correctness and assignment, and the rendering pipeline by preventing cross-corruption and isolating updates. This ensures validity, compatibility, and integrity, and prevents incomplete and corrupted assets from being used.

Preamble 1218 is a root node of the asset package and includes an avatar ID (a unique identifier for the user's avatar), an asset package version, metadata 1228 describing the avatar bundle, and/or compatibility or configuration information (e.g., protection configurations 1230). In some aspects, preamble 1218 precedes all other asset sections and acts as a header that introduces the structure, defines how to interpret the rest of the asset bundle, provides protection and verification metadata, and ensures assets from one user are not confused with another user.

In some aspects, the ARF container may host multiple blend shape sets, e.g., one blend shape set for OpenXR-based animation, and one for ARKit. A blend shape set may include a base mesh, a set of blend shape meshes. Each blend shape mesh included in the set of blend shape meshes may have exactly the same topology but with some displacements.

The Avatar Representation Format (ARF), according to ISP/IEC 23090-39, is a developing standard for representing realistic 3D human avatars in the MPEG-I framework. ARF uses a JSON-based description of an avatar's structure (geometry, textures, animations, etc.) along with associated binary asset data (mesh files, image textures, etc.). High-fidelity avatars can be quite large in size, which poses challenges for timely transmission and rendering in real-time applications.

As described herein, requiring a client to download an entire avatar file before rendering leads to high startup latency and poor user experience. To address this, the concept of progressive download, as described herein, allows an avatar to be transmitted and reconstructed in increments of quality, so that a basic version can be displayed quickly and then refined as more data arrives. Accordingly, to realize progressive download for ARF avatars by leveraging the ISO Base Media File Format (ISOBMFF) container structure and HTTP byte-range requests, partial access to avatar data is enabled in which a client can fetch just the initial portion of the file to get a coarse avatar, and progressively fetch higher Levels of Detail (LoDs) on demand.

Large avatar assets and slow initialization can be present in some cases. For example, ARF avatars can include high-resolution meshes (hundreds of thousands of polygons) and detailed texture maps (multi-megabyte images). Downloading such assets in full before use may cause significant delays. For example, an avatar with a 50 MB mesh and textures would require long wait times on typical networks before the user sees anything. This is unacceptable for interactive applications like multiplayer games, virtual reality meetings, or any real-time communication scenario where avatars represent users. As a result, various aspects described herein enable progressively transmitting and rendering avatars, such that a coarse representation (low-polygon mesh and low-res textures) becomes available quickly, and additional details are added as data continues to download.

In some cases, there can be a lack of partial access in current ARF packaging. For instance, the current working draft of ARF describes the format for avatar data but does not yet specify an efficient method for partial retrieval of that data over networks. In a naive approach, a client must fetch the entire set of asset files (or a monolithic container file) for an avatar before it can parse and display the avatar. While ARF supports Levels of Detail (LoD) conceptually (allowing multiple versions of a mesh for different complexity levels), without an integrated progressive delivery mechanism, implementations would likely resort to either sending a single LoD causing losing fidelity, or sending all LoDs separately and choosing one based on context while still requiring full download of one chosen LoD. As described herein, neither approach fully exploits the possibility of incrementally upgrading the quality. There is thus a clear need for a standardized solution that enables content discovery and partial access for avatar data, allowing clients to retrieve just what is necessary at first and then progressively refine the content.

Adaptive streaming and network variability can also be provided. For example, different networks have different network conditions. If bandwidth is limited, a progressive download scheme could allow the client to stop downloading after a certain LoD, if higher detail is not feasible, and thereby ensuring the application remains responsive. Conversely, on high bandwidth connections, the client could quickly obtain all LoDs for maximum quality. Accordingly, for compatibility with simple HTTP-based delivery (to work with existing web infrastructure) and without specialized streaming servers, the aspects described herein provide solution for how to package and transmit ARF avatar data such that clients can progressively retrieve byte ranges corresponding to incremental quality steps, and decode partial data into a usable avatar representation.

As described herein, the ISO Base Media File Format (ISOBMFF) as a container for ARF may be used to support progressive, byte-range accessible content. The solution has several key components as described below.

ISOBMFF Container Structure for ARF with LoDs:

An organization of the avatar data within an ISOBMFF file may be defined or organized such that the ARF JSON description comes first, followed by binary asset data grouped by increasing Level of Detail. All LoD asset data are stored sequentially in the file. This ordering ensures that a prefix of the file contains a complete low-detail avatar, and additional bytes correspond to higher details.

### External Index (Manifest) File

A lightweight external index (e.g., a JSON manifest) may be used that enumerates the byte ranges within the ISOBMFF file for each significant component such as, the ARF JSON document, each LoD's geometry data, each LoD's texture data, etc. This index allows a client to issue HTTP GET range requests for specific parts of the file without needing to download the whole file or parse it fully upfront.

### Inter-Dependency Coding of LoDs

As described herein, higher-detail assets may be coded as dependent enhancements of lower-detail assets. Rather than storing completely separate meshes or textures for each LoD (which would be wasteful and require duplicate base data), the higher LoD data represents difference information (deltas or residuals) that refine the lower LoD. Thus, LoD0 provides a base layer that can stand on its own, LoD1 provides data that upgrades LoD0 to a finer quality, LoD2 upgrades further, and so on. This inter-dependent layering applies to both mesh geometry and texture images.

### Progressive Parsing and Reconstruction

As described herein, the container is structured to remain parsable even if not fully downloaded. The ARF JSON (at the start of the file) can be parsed independently and contains references or placeholders for the assets. As each additional LoD chunk is downloaded, the client (or the XR device) can incrementally integrate it (e.g., add new vertices to the mesh, apply higher-resolution texture details) to progressively enhance the avatar. Even with a partial file (e.g., only the first 30% downloaded), the client will have a coherent, if lower-detail, avatar that can be displayed.

### ISOBMFF File Structure for Progressive ARF

The ISO Base Media File Format is a widely used container format (the basis for MP4, HEIF, etc.), known for its flexibility in organizing media data and metadata. ISOBMFF is leveraged to package the ARF avatar such that progressive download is enabled. In the proposed file format layout, the content may be arranged as follows:

File Header and Basic Boxes: An ftyp box identifies the file type (e.g., a brand for ARF, such as “ARF” or similar), and a moov (movie) or meta box at the beginning contains high-level metadata. This metadata includes either a manifest of item locations or track information that tells the structure of the file. Crucially, all metadata needed to find assets is at the front of the file (a concept analogous to MP4 “fast start”), so that it can be read without reading the entire file.

ARF JSON Document (Primary Scene Description): Immediately after the header/metadata, the ARF JSON text document may be placed. This JSON contains the avatar's descriptive information (e.g., scene graph, node hierarchy, materials, references to mesh and texture assets). Because of its placement at the start, the client can retrieve and parse the avatar's structure with minimal download. For example, if the ARF JSON is ~5 KB in size, a client can fetch just those first 5 KB to begin understanding the avatar contents.

Level of Detail 0 Assets (LoD0): Following the JSON, the binary assets for the lowest level of detail may be stored. LoD0 represents the base avatar—e.g., a simplified mesh (with relatively few vertices/triangles) and low-resolution texture images. These assets are encoded such that they can be used independently to render a recognizable avatar, albeit with reduced detail. LoD0 assets might be, for example, a mesh with 5 k polygons and 128×128 textures.

Level of Detail 1 Assets (LoD1): After LoD0, the next chunk of the file may contain assets for LoD1. LoD1 provides refinements that, when combined with LoD0, yield a higher-detail avatar. The data for LoD1 could include additional geometry information (e.g., vertices to increase mesh density, indices for additional triangles, or delta corrections to LoD0 vertex positions) and enhanced texture detail (e.g., higher resolution texture data or high-frequency details). LoD1's data is placed immediately after LoD0's bytes in the file.

Level of Detail 2, 3, . . . and so on: Each subsequent LoD's data may be appended sequentially. In general, LoD n assets come after LoD n−1 assets. The final LoD (highest detail) is at the end of the file. A client that downloads the entire file obtains the full-quality avatar.

As described herein, the file is thus laid out in increasing order of detail. This means a prefix of the file (from byte 0 up to the end of LoD0 region) constitutes a valid container for a coarse avatar. Extending that prefix to include LoD1 yields a valid container for a mid-quality avatar, and so on. This property directly enables progressive rendering.

The ARF document is stored first, followed by assets grouped by Level of Detail: LoD0, LoD1, LoD2. Each subsequent LoD's data is appended after the previous. Byte offsets increase from left to right, so a client can stop downloading at any LoD boundary and still have a complete avatar at that level.

As an illustrative example of byte layout, a table reproduced below may be considered for arrangement of the file by byte range for an avatar where the ARF JSON is 5 KB, LoD0 assets are 10 KB, LoD1 assets are 20 KB, and LoD2 assets are 40 KB

| | Byte | Size | |
|---|---|---|---|
| Component | Range | (bytes) | Description |
| ARF JSON | 0- | 5,000 | JSON descriptor of avatar (complete |
| Document | 4,999 | | structure, references to assets) |
| LoD0 | 5,000- | 10,000 | Base mesh (low-poly) and base |
| Assets | 14,999 | | textures (low-res) |
| LoD1 | 15,000- | 20,000 | Mesh refinement (additional |
| Assets | 34,999 | | vertices/triangles), texture |
| | | | refinement data |
| LoD2 | 35,000- | 40,000 | High-detail mesh data and high-res |
| Assets | 74,999 | | texture details (final quality) |

The structure in the above table ensures that the file is linearly scalable. If a client only needs LoD0, it only downloads the first 15 KB in this example (5K JSON+10K LoD0). To get LoD1, it downloads up to 35 KB, and so forth. Each range cleanly delimits a set of assets corresponding to a certain quality level.

In some aspects, from a container syntax perspective, the ARF JSON may be stored as a timed metadata track or as an item in a meta box, and each asset (mesh, texture) may be an ISOBMFF ‘item’ with an Item Location Box (iloc) pointing to its byte range. Alternatively, simpler custom boxes may be used to demarcate the segments. The exact boxing is left to implementation, but the principle is that the layout in bytes allows straightforward extraction of each part.

In some cases, an external index file can be provided for byte-range access. For instance, while the container is self-describing to some extent, an external index file (or manifest) in JSON format may be used to make it trivial for clients to know the exact byte ranges of each component without needing to parse the ISOBMFF boxes. This external index may be delivered alongside the avatar file (or embedded at the beginning of the file in a known location) to facilitate HTTP range requests by providing a map of component to byte range.

A possible JSON index format could be as follows:

```
{
  “file”: “avatar123.progressive.arf”,
  “components”: [
    { “name”: “ARF_JSON”, “offset”: 0, “length”: 5000 },
    { “name”: “LoD0_Geometry”, “offset”: 5000, “length”: 6000 },
    { “name”: “LoD0_Textures”, “offset”: 11000, “length”: 4000 },
    { “name”: “LoD1_GeometryDelta”, “offset”: 15000, “length”: 12000 },
    { “name”: “LoD1_TextureResidual”, “offset”: 27000, “length”: 8000 },
    { “name”: “LoD2_GeometryDelta”, “offset”: 35000, “length”: 20000 },
    { “name”: “LoD2_TextureResidual”, “offset”: 55000, “length”: 20000 }
  ]
}
```

In this example, geometry and texture within each LoD may be separated for clarity; however, they could also be grouped if always fetched together. A simpler index might list just “LoD0” with a combined range if the geometry and texture for LoD0 are contiguous. The format may further be adjusted to the needs of the implementation.

Using this index, a client may perform the following actions. First, request bytes 0-4999 (the range covering the ARF JSON), which yields the full JSON descriptor. The client then parses this JSON to understand the avatar structure. The JSON may also contain high-level info such as how many LoDs are available, identifiers for assets, etc. Second, decide which LoD to fetch initially (often LoD0). The index indicates that LoD0's geometry and textures lie in known byte ranges. The client can issue an HTTP GET with a Range header for 5000-14999 (covering all LoD0 assets). Since typical HTTP/1.1 allows a single continuous range per request, the LoD0 data may be contiguous (as in Table 1). If geometry and texture are not contiguous, multiple range requests or a combined multipart range request may be used. In some aspects, LoD assets may be stored contiguously to simplify retrieval.

As the client application renders the LoD0 avatar, it can simultaneously (or on-demand) start fetching LoD1. Again, using the index, the client application may request the byte range for LoD1 (e.g., 15000-34999). The server responds with that segment of the file. Because the client knows this corresponds to refinement data, the client merges it with the already downloaded LoD0 data. This process continues until the desired LoD is reached or the highest LoD is fully downloaded.

The external manifest approach, as described herein, has the benefit of decoupling the index from the binary file. Even if the internal structure of the file is complex, the manifest presents a simple, content-level view (e.g., “LoD1 texture from 27 KB to 34 KB”). It also makes client implementation easier such that a lightweight parser for JSON is all that is needed to drive the download logic. By way of an example, the manifest may be generated when the progressive ARF file is created and possibly even embedded as an initial JSON box in the file.

In some cases, there can be inter-dependency coding between LoDs. For instance, as described herein, while LoDs are not independent silos of data, but progressively encoded layers, and each higher LoD depends on lower LoDs' data for reconstruction. This dependency drastically reduces redundant information and total file size. As such, the lower LoD's information is reused and only the difference needed to reach the next quality level is transmitted at LoD1, at least for two main asset types in ARF avatars: mesh geometry and texture images.

Progressive mesh geometry encoding may also be provided. For example, mesh geometry for a human avatar (or any 3D object) can be encoded in a progressive manner using well-established techniques from computer graphics. LoD0 contains a base mesh with a certain number of vertices and faces. LoD1 then adds detail by refining this base mesh. There are multiple ways to implement this:

In some cases, vertex splitting and/or edge splitting may be performed. For instance, starting from the coarse mesh (LoD0), higher LoDs can introduce new vertices and edges. In one illustrative example, a vertex split operation takes one vertex and splits it into two, adjusting the connectivity (faces) accordingly, thereby increasing geometric detail. The data in LoD1 may then describe the position of the new vertex and how it connects. The client, upon receiving LoD1, applies these operations to the LoD0 mesh to refine it.

Delta Compression of Vertices: If LoD1 is essentially a higher resolution version of the same mesh (with all LoD0 vertices still present, plus additional ones), the coordinates of the LoD0 vertices in the higher detail mesh can be predicted from the LoD0 mesh. LoD1 data can then provide corrections (deltas) to those base vertices and the positions of new vertices. For example, LoD0 might approximate a curved surface with a rough shape; LoD1 may adjust the existing vertices slightly towards the true surface and add new vertices to better capture curvature. The adjustments may be coded as small differences.

Connectivity Updates: LoD1 may also carry information about new triangles (faces) formed using the new vertices, or how existing triangles are to be refined (split), which can be efficiently encoded as instructions (e.g., “split triangle X into four smaller triangles”). These instructions may depend on knowing the LoD0 mesh topology.

In some aspects, by the time all LoD layers are applied, the mesh reaches full complexity. However, higher LoDs cannot be decoded alone—for instance, the LoD2 data might say “add these 100 vertices and these 200 triangles, and adjust vertex #42's position by (+0.5 mm X, −0.2 mm Y, +0.1 mm Z)”. Without the base mesh, these instructions are meaningless. But with the base, they incrementally improve it. This dependency is by design to ensure no duplicate storage of the entire mesh at multiple qualities. The total data volume of (LoD0+LoD1+ . . . LoDn) coded in this way is much smaller than having separate full meshes for each LoD.

One practical outcome of the aspects described herein is that if a client stops downloading at LoD k, it has a mesh that is essentially the LoDk quality. If it later obtains LoD k+1, it can apply the new data on top of the existing mesh data to reach the next level. This is computationally efficient because applying deltas and adding vertices is relatively simple. Techniques from progressive mesh compression ensure that even if the differences are coded in a compressed form (like using quantization or entropy coding), the container can store them as part of the binary asset for that LOD.

In some aspects, progressive texture (Image) refinement may be performed. For example, high-resolution texture maps (which may be used for skin detail, clothing patterns, etc.) are another major component of avatar data. A progressive, inter-dependent LoD approach for textures is described herein. Two complementary techniques can be used, including residual image coding and tiled image refinement (also referred to as tiling and selective refinement).

Residual image coding can result in residual (enhancement) images. In this approach, LoD0 contains a low-resolution or highly compressed version of the texture image. For instance, LoD0 may include a 256×256 JPEG image representing the avatar's diffuse texture map. LoD1 may then contain residual data that, when added to an upsampled LoD0 image, yields a higher resolution image (say 512×512). Concretely, a base image and then an enhancement image that encodes the differences (error) between the base image (upsampled to the larger size) and the true image may be used. As a result, a lower-bandwidth version is enhanced by additional layers. The LoD1 residual might itself be encoded in an efficient format (even another JPEG or AV1 Intra refresh) but it may be useless without the base image. When the client has LoD0 and LoD1 data, it can combine them (by adding pixel values or compositing appropriately) to recover a near full-quality 512×512 texture. If more LoD layers exist (e.g., for 1024×1024), each provides further residual detail (perhaps focusing on high-frequency components). By LoD2 or LoD3, the image reaches the intended full resolution and quality.

In the tiling and selective refinement approach, a device or system (e.g., the client device) can spatially partition the texture into pieces (e.g., tiles) and progressively refine regions. For example, LoD0 can contain a low-detail version of the entire texture (as above). LoD1 might then provide higher-detail tiles for certain important regions (say the face of the avatar) while leaving other regions at low detail until a later LoD. This is useful if certain texture regions benefit more from detail first. However, this approach is more relevant when a viewer's focus is known (e.g., if the application knows the face will be seen up close before the body). In a general progressive download, the whole image may be uniformly refined. However, the container could be organized to allow non-uniform refinement if needed. In ISOBMFF, separate items for different tiles may be used and fetched as needed.

Regardless of method, a key feature of the two approaches is that LoD images build on prior LoDs. If using residuals, the summation of base and the residual yields the next level. If using tiling, base combined with the new tiles yields a more detailed composite image. Accordingly, it is ensured that LoD0 texture is fully usable on its own (perhaps blurry but correct color-wise), and higher LoDs bring it closer to full clarity. Modern image codecs like HEVC-based still images, AVIF (AV1 Image File Format), or JPEG2000 inherently support progressive decoding; those could potentially be utilized inside the container. Alternatively, a simpler multi-image approach can be used (with explicit residual images stored).

The progressive texture approach as described herein, means that if bandwidth is low, a user might only ever get the base texture—which is low-resolution but at least provides correct colors and rough details on the avatar. As more data comes, the textures sharpen. This is much better than a placeholder or no texture at all for initial frames. It also avoids downloading full high-resolution images that might not be necessary if the user moves away or the avatar is only briefly visible.

Progressive parsability and client reconstruction can be performed in some cases. A feature of this approach is that the avatar container remains parsable and decodable even when only partially downloaded by addressing or ensuring that the byte-level layout, e.g., metadata and ARF JSON are at the front, LoD data are in order. Below, it is described how a client may utilize this to reconstruct the avatar step by step:

An initial parse (ARF JSON) can be obtained. For example, a client device can fetch the ARF JSON and can parse the ARF JSON. The JSON may contain references to the various assets that make up the avatar. For example, the ARF JSON may list a mesh file (or mesh identifier) for the avatar's body, a texture file for the skin, etc. In a progressive container, these references might not be actual external file names but logical names that correspond to items in the container. The client, knowing it has a progressive container, may interpret these references in conjunction with the external index. For instance, ARF JSON might have an entry for “mesh1.lod=3” (indicating 3 levels of detail for mesh1), and the external index tells the client where to get each layer. Importantly, the ARF JSON by itself is sufficient to instantiate a basic avatar structure in memory (skeleton, empty mesh placeholder, etc.)—even though the actual geometry data is not in memory yet, the client would know what will be coming.

In some cases, partial ISOBMFF boxes may be present. For example, if the client were to parse the ISOBMFF binary itself, it would find that after the JSON, there are data boxes for LoD0, LoD1, etc. If not all are present (e.g., because the download was truncated), a compliant parser may safely ignore missing parts. Generally, an external index would provide guidance that the client need not parse the binary container deeply in view that the client knows how to fetch the needed parts directly. But even a generic ISOBMFF parser could make sense of what's downloaded: it would see, for example, the ARF JSON item and LoD0 item present, and LoD1 item incomplete or not yet fetched.

The client device can reconstruct assets on the fly. For example, once the client has downloaded the bytes for LoD0 assets, it can create the actual mesh and texture. For instance, the LoD0 geometry bytes might be a compressed mesh format (perhaps GLB, or a binary buffer of vertices and indices). The client can decode the compressed mesh format to produce a mesh object (low poly). Similarly, LoD0 texture bytes yield a low-res image bitmap. The ARF JSON might contain transform information (where to place the mesh, how to apply the texture). The client now can render a complete avatar in low detail. Further, this could happen very quickly (within a fraction of a second) if the data sizes are small.

In some cases, in-band signaling of download status can be provided. For example, the ARF JSON or container can include a field that indicates how many LoD levels exist in total. If the client knows the number of LoD levels that exist, it can present a loading progress to the user (e.g., “Avatar at 20% detail, downloading more . . . ”). The client can also manage its requests—for example, if the user's bandwidth or device cannot handle beyond LoD2, the client may stop there even if LoD3 exists.

In some cases, new data may be appended. For instance, as LoD1 bytes arrive, the client does not need to tear down and rebuild the avatar from scratch. Instead, it augments the existing avatar. Using the mesh refinement data, the client can update the geometry buffers. For instance, the client can insert new vertices and create new faces (or a new mesh LOD replaces the old mesh if using a switching mechanism. In some cases, the client may actually modify the existing mesh to preserve state like animations or deformations). For textures, new detail may come as a separate image; the client can apply the separate image by updating the texture (e.g., uploading new mip levels or replacing the texture with a higher-res one). Further, swapping a texture at runtime or updating mesh geometry buffers dynamically may also be performed.

In some aspects, parsability may be maintained. For instance, even if the download stops at some point, the file remains a valid partial file containing at least the portions downloaded. In one illustrative example, if only ARF JSON and LoD0 are downloaded, the file essentially is an ISOBMFF containing the avatar JSON and base assets-which is perfectly usable. In essence, each prefix of the file that ends at a LoD boundary may be considered a self-contained valid file for a lower-detail avatar. This property is beneficial for robustness such that, if a download is interrupted, the user still has a usable avatar representation (not just a corrupt file). The client can even store that partial file as a cache and later resume to get higher LoDs.

In some aspects, the ARF ISOBMFF container may use an index (either internal or external) such that a reader can identify items available in a partial file. Item Locator boxes inside moov which list byte offsets of all items (similar to how HEIF image containers list offsets of images) may be used. If those offsets are known from the beginning, a partial file still contains a correct listing of where each item would be (though not all bytes are present until downloaded). A parser can skip over missing bytes, or an HTTP connection can simply not serve them. The external manifest approach outlined herein is effectively a human-readable version of such an index.

Accordingly, the ARF, as referenced herein, supports multiple animation frameworks with animation of facial expressions, body, hand, etc., with multiple levels of details (LoDs) for providing partial and/or full access to an avatar. Additionally, the ARF also supports authentication related features for security.

A real-world scenario, where the aspects described herein may be used, is a multi-party video conference in AR/VR where each participant is represented by a personalized 3D avatar. When a new participant joins the session, their avatar data can be transmitted to all other participants (or a central server that relays to others). Using the progressive ARF approach described herein, the following use case can be performed:
Session Join: Participant A joins, and their avatar (described in ARF) begins transmitting to participant B. Rather than sending dozens of files or one huge model, participant A's system (or the server) sends the ARF container file which participant B starts to receive.

Initial Appearance: Within a very short time, participant B's client has downloaded the first 100 kilobytes (for example) of participant A's avatar file. This includes the ARF JSON and LoD0 assets. Participant B's client parses the JSON, learns the avatar's structure (e.g., there is a body mesh, a hair mesh, two texture maps, etc.), and decodes the LoD0 mesh and textures. Participant B's display now shows participant A's avatar as a simple, low-detail model—maybe the facial features are blurry and the body shape is slightly blocky, but it is immediately visible. Importantly, the avatar's movements (if participant A is animating or speaking) can already be applied because the skeleton and basic mesh are present.

Progressive Refinement: As the conversation continues, participant B's client fetches LoD1 and LoD2 of participant A's avatar in the background (assuming participant A remains in the session and bandwidth permits). After another second, LoD1 data arrives. Participant B's client applies the mesh refinement: suddenly participant A's avatar's face becomes more detailed, fingers on the hands appear separately (where previously maybe the hand was mitten-like), and the clothing gains wrinkles via the improved geometry and textures. Because this is done seamlessly, participant B just observes that participant A's avatar “resolves” into a sharper version after a moment—analogous to how a low-res video stream might sharpen when bandwidth improves, but here it's deterministic as data arrives.

Full Quality and Interactivity: Finally, LoD2 (the highest) arrives, perhaps containing fine facial details, high-resolution normal maps for skin pores, etc. Participant B's client incorporates these, and now Participant A's avatar is at full fidelity, indistinguishable from if participant B had loaded the full model from the start-except participant B didn't have to wait at the start to see something. All this while, if participant A had started talking or moving, those animations (which are typically low-bandwidth skeleton data) could be applied to whatever LoD was available. The progressive geometry ensures that even if bones move, the mesh updates remain valid across LoDs (the same skeletal rig drives all LoDs).

Bandwidth Adaptation: If the network was slower, participant B's client might decide to pause after getting LoD1 and not attempt LoD2 until later or unless needed (for example, if participant A's avatar comes very close in an AR scenario, maybe then participant B would fetch LoD2 for extreme close-up detail). The external index allows participant B to choose which ranges to download and when, so this can be dynamic. In a broadcast scenario, the server could even instruct clients to only pull up to a certain LoD based on global bandwidth or device capabilities (some participants on mobile might never get LoD3 if their device can't render it efficiently).

This use case demonstrates how real-time avatar streaming benefits from progressive download. The initial latency to appearance of an avatar is minimized, enhancing user experience. Yet, quality is not sacrificed—it's incrementally delivered. Even in non-conversational settings, for example, a virtual world game, as a new character model comes into the player's view, the engine can use the same method to stream that character's assets: show a basic version in a fraction of a second, then refine it.

Accordingly, aspects described herein support progressive download and rendering of MPEG-I ARF avatars using the ISOBMFF-based container and LoD-based layering of content. Further, the aspects described herein address the issue of large base avatar downloading times by allowing partial, incremental data access and decoding.

Various animation assets may be needed to model a virtual representation or avatar and/or to generate an animation of the virtual representation or avatar. For example, one or more meshes (e.g., including a plurality of vertices, edges, and/or faces in three-dimensional space) with corresponding materials may be used to represent an avatar of a user. The materials may include a normal texture (e.g., represented by a normal map), a diffuse or albedo texture, a specular reflection texture, any combination thereof, and/or other materials or textures. For instance, an animated avatar is an animated mesh and the corresponding assets (e.g., normal, albedo, specular reflection, etc.) for every frame. FIG. 13 is a diagram illustrating an example of a mesh 1301 of a user, an example of a normal map 1302 of the user, an example of an albedo map 1304 of the user, an example of a specular reflection map 1306 of the user, and an example of personalized parameters 1308 for the user. For example, the personalized parameters 1308 can be neural network parameters (e.g., weights, biases, etc.) that can be retrained beforehand, fine-tuned, or set by the user. The various materials or textures may need to be available from enrollment or offline reconstruction.

In some aspects, assets can be either view dependent (e.g., generated for a certain view pose) or can be view independent (e.g., generated for all possible view poses). In some cases, realism may be compromised for view independent assets.

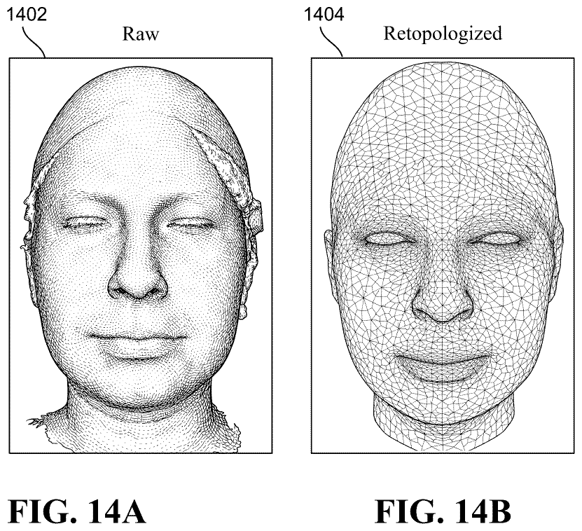

A goal of generating an avatar for a user is to generate a mesh with the various materials (e.g., normal, albedo, specular reflection, etc.) for the user. In some cases, a mesh must be of a known topology. However, meshes from scanners (e.g., LightCage, 3DMD, etc.) may not satisfy such a constraint. To solve such an issue, a mesh can be retopologized after scanning, which would make the mesh parametrized. FIG. 14A is a diagram illustrating an example of a raw (non-retopologized) mesh 1402. FIG. 14B is a diagram illustrating an example of a retopologized mesh 1404. Retopologizing a mesh for a virtual representation or avatar results in the mesh becoming parametrized with a number of animation parameters that define how the avatar will be animated during a virtual session.

Animation of a virtual representation (e.g., avatar) can be performed using various techniques including split or hybrid rendering, gradual transitioning of rendering, a mixed-rendering session, a voice-only session start, a progressive or partial download, and/or pre-loaded avatar base models, as described herein.

In some aspects, blend shapes animation corresponds with deformation of the mesh representing facial expressions. By way of an example, a weight between 0 and 1 may be used for selecting the deformation, and blend shapes may be combined to reconstruct the face using

$${v}_{0 ut} = {v}_{0} + {\sum }_{1}^{n} {w}_{i} * ( {v}_{i} - {v}_{0} ) ,$$

wherein vₒᵤₜ represents a combined vertex, v₀ represents a neutral vertex, wᵢ represents a weight for blend shape i, and vᵢ represents a vertex for blend shape i.

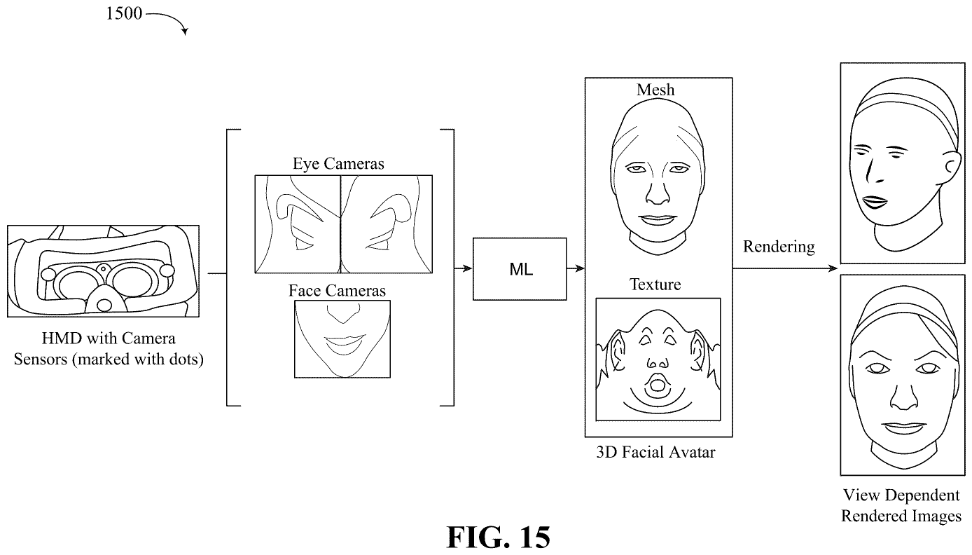

FIG. 15 is a diagram 1500 illustrating an example of one technique for performing avatar animation. As shown, camera sensors of a head-mounted display (HMD) are used to capture images of a user's face, including eye cameras used to capture images of the user's eyes, face cameras used to capture the visible part of the face (e.g., mouth, chin, cheeks, part of the nose, etc.), and other sensors for capturing other sensor data (e.g., audio, etc.). A machine learning (ML) model (e.g., a neural network model) can process the images to generate a 3D mesh and texture for the 3D facial avatar. The mesh and texture can then be rendered by a rendering engine to generate a rendered image (e.g., view-dependent renders, as shown in FIG. 15).

Large data transmission rates may be needed to transmit mesh information and animation parameters for a mesh between devices for animation of an avatar to facilitate an interactive virtual experience between users. For instance, the parameters may need to be transmitted from one device of a first user to a second device of a second user for every frame at a frame rate of 30-60 frames per second (FPS) so that the second device can animate the avatar for each frame being rendered at the frame rate.

As discussed previously, systems and techniques are also described herein for providing an efficient communication framework for virtual representation calls for a virtual environment (e.g., a metaverse virtual environment). In some aspects, a flow for setting up an avatar call can be performed directly between client devices (also referred to as user devices) or can be performed via a server. Additionally, systems and techniques are also described herein for providing an efficient communication framework for virtual representation calls for the virtual environment by performing, or using, split or hybrid rendering, gradual transitioning of rendering, a mixed-rendering session, a voice-only session start, a progressive or partial download, and/or pre-loaded avatar base models, as described herein.

According to aspects described herein, the systems and techniques can provide for reduced transmission data rates when transmitting information used for animating virtual representations of users based upon split or hybrid rendering, gradual transitioning of rendering, a mixed-rendering session, a voice-only session start, a progressive or partial download, and/or pre-loaded avatar base models.

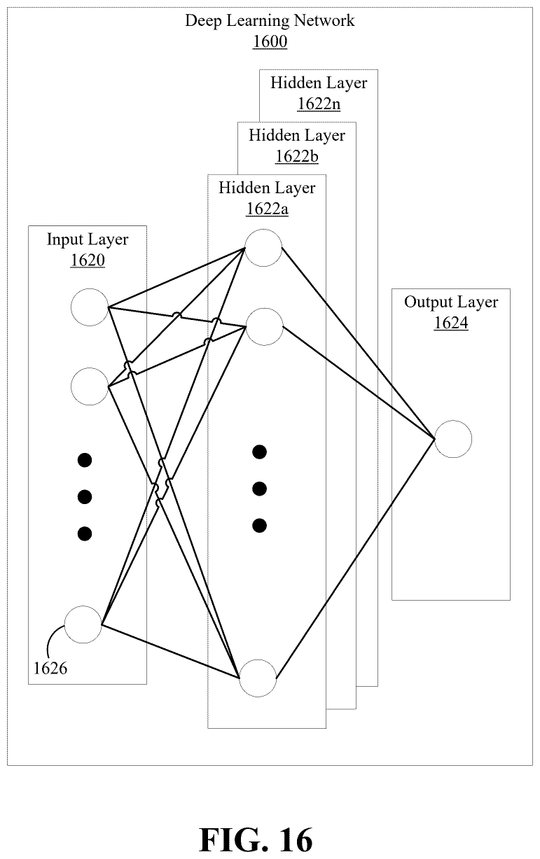

As described herein, various aspects may be implemented using a deep network, such as a neural network or multiple neural networks. FIG. 16 is an illustrative example of a deep learning neural network 1600 that can be used by a 3D model training system. An input layer 1620 includes input data. In one illustrative example, the input layer 1620 can include data representing the pixels of an input video frame. The neural network 1600 includes multiple hidden layers 1622a, 1622b, through 1622n. The hidden layers 1622a, 1622b, through 1622n include “n” number of hidden layers, where “n” is an integer greater than or equal to one. The number of hidden layers can be made to include as many layers as needed for the given application. The neural network 1600 further includes an output layer 1624 that provides an output resulting from the processing performed by the hidden layers 1622a, 1622b, through 1622n. In one illustrative example, the output layer 1624 can provide a classification for an object in an input video frame. The classification can include a class identifying the type of object (e.g., a person, a dog, a cat, or other object).

The neural network 1600 is a multi-layer neural network of interconnected nodes. Each node can represent a piece of information. Information associated with the nodes is shared among the different layers and each layer retains information as information is processed. In some cases, the neural network 1600 can include a feed-forward network, in which case there are no feedback connections where outputs of the network are fed back into itself. In some cases, the neural network 1600 can include a recurrent neural network, which can have loops that allow information to be carried across nodes while reading in input.

Information can be exchanged between nodes through node-to-node interconnections between the various layers. Nodes of the input layer 1620 can activate a set of nodes in the first hidden layer 1622a. For example, as shown, each of the input nodes of the input layer 1620 is connected to each of the nodes of the first hidden layer 1622a. The nodes of the hidden layers 1622a, 1622b, through 1622n can transform the information of each input node by applying activation functions to the information. The information derived from the transformation can then be passed to and can activate the nodes of the next hidden layer 1622b, which can perform their own designated functions. Example functions include convolutional, up-sampling, data transformation, and/or any other suitable functions. The output of the hidden layer 1622b can then activate nodes of the next hidden layer, and so on. The output of the last hidden layer 1622n can activate one or more nodes of the output layer 1624, at which an output is provided. In some cases, while nodes (e.g., node 1626) in the neural network 1600 are shown as having multiple output lines, a node has a single output and all lines shown as being output from a node represent the same output value.

In some cases, each node or interconnection between nodes can have a weight that is a set of parameters derived from the training of the neural network 1600. Once the neural network 1600 is trained, it can be referred to as a trained neural network, which can be used to classify one or more objects. For example, an interconnection between nodes can represent a piece of information learned about the interconnected nodes. The interconnection can have a tunable numeric weight that can be tuned (e.g., based on a training dataset), allowing the neural network 1600 to be adaptive to inputs and able to learn as more and more data is processed.

The neural network 1600 is pre-trained to process the features from the data in the input layer 1620 using the different hidden layers 1622a, 1622b, through 1622n in order to provide the output through the output layer 1624. In an example in which the neural network 1600 is used to identify objects in images, the neural network 1600 can be trained using training data that includes both images and labels. For instance, training images can be input into the network, with each training image having a label indicating the classes of the one or more objects in each image (basically, indicating to the network what the objects are and what features they have). In one illustrative example, a training image can include an image of a number 2, in which case the label for the image can be [0 0 1 0 0 0 0 0 0 0].

In some cases, the neural network 1600 can adjust the weights of the nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until the neural network 1600 is trained well enough so that the weights of the layers are accurately tuned.

For the example of identifying objects in images, the forward pass can include passing a training image through the neural network 1600. The weights are initially randomized before the neural network 1600 is trained. The image can include, for example, an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

For a first training iteration for the neural network 1600, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 1600 is unable to determine low level features and thus cannot make an accurate determination of what the classification of the object might be. A loss function can be used to analyze error in the output. Any suitable loss function definition can be used. One example of a loss function includes a mean squared error (MSE). The MSE is defined as

$${E}_{total} = \sum \frac{1}{2} {( target - output )}^{2} ,$$

which calculates the sum of one-half times the actual answer minus the predicted (output) answer squared. The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. The neural network 1600 can perform a backward pass by determining which inputs (weights) most contributed to the loss of the network, and can adjust the weights so that the loss decreases and is eventually minimized.

A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{dL}{dW} ,$$

where w denotes a weight, wᵢ denotes the initial weight, and n denotes a learning rate. The learning rate can be set to any suitable value, with a high learning rate including larger weight updates and a lower value indicating smaller weight updates.

The neural network 1600 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. The neural network 1600 can include any other deep network other than a CNN, such as an autoencoder, a deep belief nets (DBNs), a Recurrent Neural Networks (RNNs), among others.

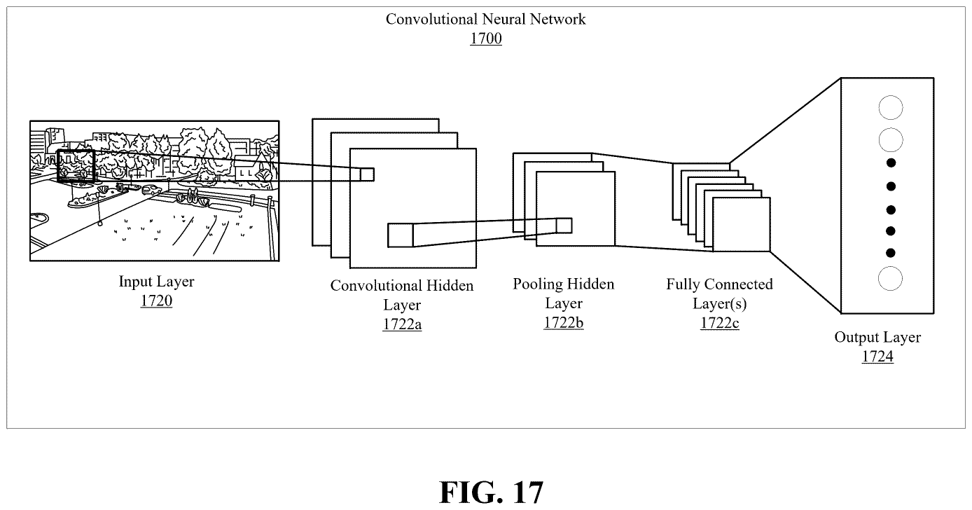

FIG. 17 is an illustrative example of a convolutional neural network (CNN) 1700. The input layer 1720 of the CNN 1700 includes data representing an image. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1722a, an optional non-linear activation layer, a pooling hidden layer 1722b, and fully connected hidden layers 1722c to get an output at the output layer 1724. While only one of each hidden layer is shown in FIG. 17, one of ordinary skill will appreciate that multiple convolutional hidden layers, non-linear layers, pooling hidden layers, and/or fully connected layers can be included in the CNN 1700. As previously described, the output can indicate a single class of an object or can include a probability of classes that best describe the object in the image.

The first layer of the CNN 1700 is the convolutional hidden layer 1722a. The convolutional hidden layer 1722a analyzes the image data of the input layer 1720. Each node of the convolutional hidden layer 1722a is connected to a region of nodes (pixels) of the input image called a receptive field. The convolutional hidden layer 1722a can be considered as one or more filters (each filter corresponding to a different activation or feature map), with each convolutional iteration of a filter being a node or neuron of the convolutional hidden layer 1722a. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 1722a. Each connection between a node and a receptive field for that node learns a weight and, in some cases, an overall bias such that each node learns to analyze its particular local receptive field in the input image. Each node of the hidden layer 1722a will have the same weights and bias (called a shared weight and a shared bias). For example, the filter has an array of weights (numbers) and the same depth as the input. A filter will have a depth of 3 for the video frame example (according to three color components of the input image). An illustrative example size of the filter array is 5×5×3, corresponding to a size of the receptive field of a node.

The convolutional nature of the convolutional hidden layer 1722a is due to each node of the convolutional layer being applied to its corresponding receptive field. For example, a filter of the convolutional hidden layer 1722a can begin in the top-left corner of the input image array and can convolve around the input image. As noted above, each convolutional iteration of the filter can be considered a node or neuron of the convolutional hidden layer 1722a. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1722a.

For example, a filter can be moved by a step amount to the next receptive field. The step amount can be set to 1 or another suitable amount. For example, if the step amount is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1722a.

The mapping from the input layer to the convolutional hidden layer 1722a is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a step amount of 1) of a 28×28 input image. The convolutional hidden layer 1722a can include several activation maps in order to identify multiple features in an image. The example shown in FIG. 17 includes three activation maps. Using three activation maps, the convolutional hidden layer 1722a can detect three different kinds of features, with each feature being detectable across the entire image.

In some examples, a non-linear hidden layer can be applied after the convolutional hidden layer 1722a. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 1700 without affecting the receptive fields of the convolutional hidden layer 1722a.

The pooling hidden layer 1722b can be applied after the convolutional hidden layer 1722a (and after the non-linear hidden layer when used). The pooling hidden layer 1722b is used to simplify the information in the output from the convolutional hidden layer 1722a. For example, the pooling hidden layer 1722b can take each activation map output from the convolutional hidden layer 1722a and generates a condensed activation map (or feature map) using a pooling function. Max-pooling is one example of a function performed by a pooling hidden layer. Other forms of pooling functions be used by the pooling hidden layer 1722a, such as average pooling, L2-norm pooling, or other suitable pooling functions. A pooling function (e.g., a max-pooling filter, an L2-norm filter, or other suitable pooling filter) is applied to each activation map included in the convolutional hidden layer 1722a. In the example shown in FIG. 17, three pooling filters are used for the three activation maps in the convolutional hidden layer 1722a.

In some examples, max-pooling can be used by applying a max-pooling filter (e.g., having a size of 2×2) with a step amount (e.g., equal to a dimension of the filter, such as a step amount of 2) to an activation map output from the convolutional hidden layer 1722a. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1722a having a dimension of 24×24 nodes, the output from the pooling hidden layer 1722b will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

Intuitively, the pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1700.

The final layer of connections in the network is a fully-connected layer that connects every node from the pooling hidden layer 1722b to every one of the output nodes in the output layer 1724. Using the example above, the input layer includes 28×28 nodes encoding the pixel intensities of the input image, the convolutional hidden layer 1722a includes 3×24×24 hidden feature nodes based on application of a 5×5 local receptive field (for the filters) to three activation maps, and the pooling layer 1722b includes a layer of 3×12×12 hidden feature nodes based on application of max-pooling filter to 2×2 regions across each of the three feature maps. Extending this example, the output layer 1724 can include ten output nodes. In such an example, every node of the 3×12×12 pooling hidden layer 1722b is connected to every node of the output layer 1724.

The fully connected layer 1722c can obtain the output of the previous pooling layer 1722b (which should represent the activation maps of high-level features) and determines the features that most correlate to a particular class. For example, the fully connected layer 1722c layer can determine the high-level features that most strongly correlate to a particular class and can include weights (nodes) for the high-level features. A product can be computed between the weights of the fully connected layer 1722c and the pooling hidden layer 1722b to obtain probabilities for the different classes. For example, if the CNN 1700 is being used to predict that an object in a video frame is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 1724 can include an M-dimensional vector (in the prior example, M=10), where M can include the number of classes that the program has to choose from when classifying the object in the image. Other example outputs can also be provided. Each number in the N-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

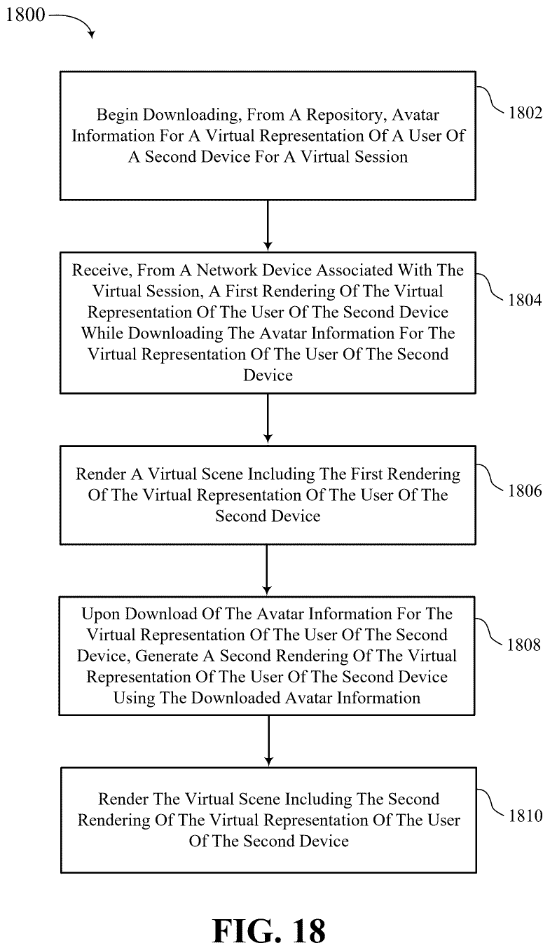

FIG. 18 is a flow diagram of an example of a process 1800 for generating virtual content at a first device of a distributed system. According to aspects described herein, the first device may include a client device (e.g., an XR device), such as one of the client devices described with respect to any of FIGS. 6-12. In some examples, a component (e.g., a chipset, processor, memory, any combination thereof, and/or other component may perform one or more of the operations of the process 1800).

At block 1802, the first device (or component thereof) may begin downloading avatar information for a virtual representation of a user of a second device for a virtual session. Avatar information may be downloaded from a repository that is communicatively coupled with the first device (or component thereof). The downloaded avatar information is associated with a base virtual representation of the user of the second device at a first level of quality.

At block 1804, the first device (or component thereof) may receive a first rendering of the virtual representation of the user of the second device. The first rendering of the virtual representation of the user of the second device may be received from a network device associated with the virtual session while downloading the avatar information for the virtual representation of the user of the second device. The first rendering can be a 2D image/frame, 2.5D with depth, or 3D mesh, and the first device composes the first rendering into a scene graph.

At block 1806, the first device (or component thereof) may render a virtual scene. The virtual scene may include the first rendering of the virtual representation of the user of the second device.

At block 1808, the first device (or component thereof) may generate a second rendering of the virtual representation of the user of the second device using the downloaded avatar information. The second rendering of the virtual representation of the user of the second device may be generated upon downloading of the avatar information for the virtual representation of the user of the second device.

At block 1810, the first device (or component thereof) may render the virtual scene including the second rendering of the virtual representation of the user of the second device.

In some aspects, as described herein, the avatar information is rendered at the network device while avatar information for virtual representations of multiple users associated with the virtual session are downloaded in parallel by the first device. In some cases, enhancement information for the virtual representation of the user of the second device may be received from the network device, and the second rendering of the virtual representation of the user of the second device at a second level of quality may be generated. For example, the second level of quality is greater than the first level of quality.

In some cases, a rendering of a virtual representation of a user of a third device may be received from the network device. In such cases, the virtual scene including the second rendering of the virtual representation of the user of the second device and the virtual representation of the user of the third device may be rendered.

In some examples, the virtual session may be initiated as a voice-only session prior to downloading the avatar information for the virtual representation of the user of the second device. Further, avatar information for the virtual representation of the user of the second device may be encoded to gradually increase a quality of the virtual representation of the user of the second device.

In some examples, the avatar information for the virtual representation of the user of the second device may be stored locally at the first device for subsequent use during at least one additional virtual session.

The components of the device or apparatus configured to carry out one or more operations of the process 1800 and/or other processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 1800 is illustrated as a logical flow diagram, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein (e.g., the process 1800 and/or other processes) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

FIG. 19 is a diagram illustrating an example of a system for implementing certain aspects of the present technology. In particular, FIG. 19 illustrates an example of computing system 1900, which can be for example any computing device making up internal computing system, a remote computing system, a camera, or any component thereof in which the components of the system are in communication with each other using connection 1905. Connection 1905 can be a physical connection using a bus, or a direct connection into processor 1912, such as in a chipset architecture. Connection 1905 can also be a virtual connection, networked connection, or logical connection.

In some aspects, computing system 1900 is a distributed system in which the functions described in this disclosure can be distributed within a datacenter, multiple data centers, a peer network, etc. In some aspects, one or more of the described system components represents many such components, each performing some or all of the function for which the component is described. In some aspects, the components can be physical or virtual devices.

Example system 1900 includes at least one processing unit (CPU or processor) 1910 and connection 1905 that couples various system components including system memory 1915, such as read-only memory (ROM) 1920 and random-access memory (RAM) 1925 to processor 1912. Computing system 1900 can include a cache 1911 of high-speed memory connected directly with, in close proximity to, or integrated as part of processor 1912.

Processor 1912 can include any general-purpose processor and a hardware service or software service, such as services 1932, 1934, and 1936 stored in storage device 1930, configured to control processor 1912 as well as a special-purpose processor where software instructions are incorporated into the actual processor design. Processor 1912 may essentially be a completely self-contained computing system, containing multiple cores or processors, a bus, memory controller, cache, etc. A multi-core processor may be symmetric or asymmetric.

To enable user interaction, computing system 1900 includes an input device 1945, which can represent any number of input mechanisms, such as a microphone for speech, a touch-sensitive screen for gesture or graphical input, keyboard, mouse, motion input, speech, etc. Computing system 1900 can also include output device 1935, which can be one or more of a number of output mechanisms. In some instances, multimodal systems can enable a user to provide multiple types of input/output to communicate with computing system 1900. Computing system 1900 can include communications interface 1940, which can generally govern and manage the user input and system output.

The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, WLAN signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/long term evolution (LTE) cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1940 may also include one or more GNSS receivers or transceivers that are used to determine a location of the computing system 1900 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1930 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a Europay, Mastercard and Visa (EMV) chip, a subscriber identity module (SIM) card, a mini/micro/nano/pico SIM card, another integrated circuit (IC) chip/card, RAM, static RAM (SRAM), dynamic RAM (DRAM), ROM, programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 1930 can include software services, servers, services, etc., that when the code that defines such software is executed by the processor 1912, it causes the system to perform a function. In some aspects, a hardware service that performs a particular function can include the software component stored in a computer-readable medium in connection with the necessary hardware components, such as processor 1912, connection 1905, output device 1935, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory, or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Claim language or other language reciting “at least one processor configured to,” “at least one processor being configured to,” “a processor configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:
Aspect 1: An apparatus of a first device for generating virtual content in a distributed system, the apparatus including: at least one memory; and at least one processor coupled to the at least one memory and configured to: begin downloading, from a repository, avatar information for a virtual representation of a user of a second device for a virtual session; receive, from a network device associated with the virtual session, a first rendering of the virtual representation of the user of the second device while downloading the avatar information for the virtual representation of the user of the second device; render a virtual scene including the first rendering of the virtual representation of the user of the second device; upon download of the avatar information for the virtual representation of the user of the second device, generate a second rendering of the virtual representation of the user of the second device using the downloaded avatar information; and render the virtual scene including the second rendering of the virtual representation of the user of the second device.
Aspect 2: The apparatus of Aspect 1, wherein the avatar information is rendered at the network device while avatar information for virtual representations of multiple users associated with the virtual session are downloaded in parallel by the first device.
Aspect 3: The apparatus of Aspect 1 or 2, wherein the downloaded avatar information is associated with a base virtual representation of the user of the second device at a first level of quality, and wherein the at least one processor is configured to: receive, from the network device, enhancement information for the virtual representation of the user of the second device; and generate the second rendering of the virtual representation of the user of the second device at a second level of quality, wherein the second level of quality is greater than the first level of quality.
Aspect 4: The apparatus of any of Aspects 1 to 3, wherein the at least one processor is configured to: receive, from the network device, a rendering of a virtual representation of a user of a third device; and render the virtual scene including the second rendering of the virtual representation of the user of the second device and the rendering of the virtual representation of the user of the third device.
Aspect 5: The apparatus of any of Aspects 1 to 4, wherein the virtual session is initiated as a voice-only session prior to downloading the avatar information for the virtual representation of the user of the second device.
Aspect 6: The apparatus of any of Aspects 1 to 5, wherein avatar information for the virtual representation of the user of the second device is encoded to gradually increase a quality of the virtual representation of the user of the second device.
Aspect 7: The apparatus of any of Aspects 1 to 6, wherein the avatar information for the virtual representation of the user of the second device is stored locally at the first device for subsequent use during at least one additional virtual session.
Aspect 8: A method of generating virtual content at a first device in a distributed system, the method comprising: begin downloading, from a repository, avatar information for a virtual representation of a user of a second device for a virtual session; receiving, from a network device associated with the virtual session, a first rendering of the virtual representation of the user of the second device while downloading the avatar information for the virtual representation of the user of the second device; rendering a virtual scene including the first rendering of the virtual representation of the user of the second device; upon downloading of the avatar information for the virtual representation of the user of the second device, generating a second rendering of the virtual representation of the user of the second device using the downloaded avatar information; and rendering the virtual scene including the second rendering of the virtual representation of the user of the second device.
Aspect 9: The method of Aspect 8, wherein the avatar information is rendered at the network device while avatar information for virtual representations of multiple users associated with the virtual session are downloaded in parallel by the first device.
Aspect 10: The method of Aspect 8 or 9, wherein the downloaded avatar information is associated with a base virtual representation of the user of the second device at a first level of quality, and the method further comprising receiving, from the network device, enhancement information for the virtual representation of the user of the second device; and generating the second rendering of the virtual representation of the user of the second device at a second level of quality, wherein the second level of quality is greater than the first level of quality.
Aspect 11: The method of any of Aspects 8 to 10, further comprising receiving, from the network device, a rendering of a virtual representation of a user of a third device; and rendering the virtual scene including the second rendering of the virtual representation of the user of the second device and the rendering of the virtual representation of the user of the third device.
Aspect 12: The method of any of Aspects 8 to 11, wherein the virtual session is initiated as a voice-only session prior to downloading the avatar information for the virtual representation of the user of the second device.
Aspect 13: The method of any of Aspects 8 to 12, wherein avatar information for the virtual representation of the user of the second device is encoded to gradually increase a quality of the virtual representation of the user of the second device.
Aspect 14: The method of any of Aspects 8 to 13, wherein the avatar information for the virtual representation of the user of the second device is stored locally at the first device for subsequent use during at least one additional virtual session.
Aspect 15: A non-transitory computer-readable medium having stored thereon instructions that, when executed by at least one processor, cause the at least one processor to perform operations according to any of Aspects 8 to 14.
Aspect 16: An apparatus for generating virtual content, the apparatus including one or more means for performing operations according to any of Aspects 8 to 14.
Aspect 17: An apparatus of a first device for generating virtual content in a distributed system, the apparatus including: at least one memory; and at least one processor coupled to the at least one memory and configured to: detect a set of active blendshapes for a virtual representation of a user of a second device; receive, from a network device, enhancement data for at least one active blendshape that refines a locally available lower-quality blendshape to a higher level of quality; apply the enhancement data to render a frame including the virtual representation of the user; and store the enhancement data in association with the blendshape for reuse in rendering one or more subsequent frames.
Aspect 18: The apparatus of Aspect 17, wherein the network device selects which blendshape enhancements to transmit based on at least one of: blendshape activity frequency, a bandwidth budget, or a predicted attention metric.
Aspect 19: The apparatus of Aspect 17 or 18, wherein the enhancement data includes at least one of: vertex deltas, connectivity updates, higher-resolution texture information, normal or specular residuals, or shader parameters.
Aspect 20: The apparatus of any of Aspects 17 to 19, wherein the first device maintains a cache indexed by blendshape identifier and level of detail, and evicts entries based on usage statistics.
Aspect 21: A method performed by an apparatus in a distributed system, the method including: while a first device downloads avatar information for a virtual representation of a user of a second device from a Base Avatar Repository (BAR), receiving, at a Media Function (MF), motion or animation information for the user; rendering, at the MF, a first rendering of the virtual representation and transmitting the first rendering toward the first device; and responsive to a completion indication that the first device has downloaded the avatar information, ceasing the rendering at the MF and transmitting, toward the first device, animation parameters for local rendering of the virtual representation, wherein the completion indication is received from one of: the first device, the BAR, or internal state when the MF and the BAR are co-located.
Aspect 22: The method of Aspect 21, wherein the completion indication identifies a level of detail available at the first device.
Aspect 23: The method of Aspect 21 or Aspect 22, further including continuing to render, at the MF, a second virtual representation for a third user while the first device locally renders the virtual representation of the second device.
Aspect 24: A non-transitory computer-readable medium having stored thereon instructions that, when executed by one or more processors, cause the one or more processors to perform operations according to any of Aspects 21 to 23.
Aspect 25: An apparatus comprising one or more means for performing operations according to any of Aspects 21 to 23.
Aspect 26: An apparatus including at least one memory and at least one processor coupled to the at least one memory and configured to: determine a target level of detail for each of a plurality of virtual representations based on at least one of gaze direction, angular proximity to gaze, scene distance, or conversational salience; and schedule downloads of avatar information and/or enhancement data according to the target level of detail.
Aspect 27: The apparatus of Aspect 26, wherein an active speaker is assigned a minimum target level of detail independent of gaze direction.
Aspect 28: A method comprising: determining a target level of detail for each of a plurality of virtual representations based on at least one of gaze direction, angular proximity to gaze, scene distance, or conversational salience; and scheduling downloads of avatar information and/or enhancement data according to the target level of detail.
Aspect 29: The method of Aspect 28, wherein an active speaker is assigned a minimum target level of detail independent of gaze direction.
Aspect 30: A non-transitory computer-readable medium having stored thereon instructions that, when executed by one or more processors, cause the one or more processors to perform operations according to any of Aspects 28 or 29.
Aspect 31: An apparatus comprising one or more means for performing operations according to any of Aspects 28 or 29.
Aspect 32: An apparatus including at least one memory and at least one processor coupled to the at least one memory and configured to: receive 2D avatar frames for a remote user and a corresponding depth map from a network device; predict a pose of the first device; reprojecting the 2D avatar frames based on the predicted pose to generate a panel view; and transition from the panel view to mesh-based rendering of the avatar responsive to the first device downloading avatar information at or above a threshold level of detail.
Aspect 33: A method performed by a first device, the method including: receiving 2D avatar frames for a remote user and a corresponding depth map from a network device; predicting a pose of the first device; reprojecting the 2D avatar frames based on the predicted pose to generate a panel view; and transitioning from the panel view to mesh-based rendering of the avatar responsive to the first device downloading avatar information at or above a threshold level of detail.
Aspect 34: A non-transitory computer-readable medium having stored thereon instructions that, when executed by one or more processors, cause the one or more processors to: receive 2D avatar frames for a remote user and a corresponding depth map from a network device; predict a pose of the first device; reprojecting the 2D avatar frames based on the predicted pose to generate a panel view; and transition from the panel view to mesh-based rendering of the avatar responsive to the first device downloading avatar information at or above a threshold level of detail.
Aspect 35: An apparatus including: means for receiving 2D avatar frames for a remote user and a corresponding depth map from a network device; means for predicting a pose of the first device; means for reprojecting the 2D avatar frames based on the predicted pose to generate a panel view; and means for transitioning from the panel view to mesh-based rendering of the avatar responsive to the first device downloading avatar information at or above a threshold level of detail.

What is claimed is:

1. An apparatus for generating virtual content at a first device in a distributed system, the apparatus comprising:
at least one memory; and
at least one processor coupled to the at least one memory and configured to:
begin downloading, from a repository, avatar information for a virtual representation of a user of a second device for a virtual session;
receive, from a network device associated with the virtual session, a first rendering of the virtual representation of the user of the second device while downloading the avatar information for the virtual representation of the user of the second device;
render a virtual scene including the first rendering of the virtual representation of the user of the second device;
upon download of the avatar information for the virtual representation of the user of the second device, generate a second rendering of the virtual representation of the user of the second device using the downloaded avatar information; and
render the virtual scene including the second rendering of the virtual representation of the user of the second device.

2. The apparatus of claim 1, wherein the avatar information is rendered at the network device while avatar information for virtual representations of multiple users associated with the virtual session are downloaded in parallel by the first device.

3. The apparatus of claim 1, wherein the downloaded avatar information is associated with a base virtual representation of the user of the second device at a first level of quality, and wherein the at least one processor is configured to:
receive, from the network device, enhancement information for the virtual representation of the user of the second device; and
generate the second rendering of the virtual representation of the user of the second device at a second level of quality, wherein the second level of quality is greater than the first level of quality.

4. The apparatus of claim 1, wherein the at least one processor is configured to:
receive, from the network device, a rendering of a virtual representation of a user of a third device; and
render the virtual scene including the second rendering of the virtual representation of the user of the second device and the rendering of the virtual representation of the user of the third device.

5. The apparatus of claim 1, wherein the virtual session is initiated as a voice-only session prior to downloading the avatar information for the virtual representation of the user of the second device.

6. The apparatus of claim 1, wherein avatar information for the virtual representation of the user of the second device is encoded to gradually increase a quality of the virtual representation of the user of the second device.

7. The apparatus of claim 1, wherein the avatar information for the virtual representation of the user of the second device is stored locally at the first device for subsequent use during at least one additional virtual session.

8. A method of generating virtual content at a first device in a distributed system, the method comprising:
begin downloading, from a repository, avatar information for a virtual representation of a user of a second device for a virtual session;
receiving, from a network device associated with the virtual session, a first rendering of the virtual representation of the user of the second device while downloading the avatar information for the virtual representation of the user of the second device;
rendering a virtual scene including the first rendering of the virtual representation of the user of the second device;
upon downloading of the avatar information for the virtual representation of the user of the second device, generating a second rendering of the virtual representation of the user of the second device using the downloaded avatar information; and
rendering the virtual scene including the second rendering of the virtual representation of the user of the second device.

9. The method of claim 8, wherein the avatar information is rendered at the network device while avatar information for virtual representations of multiple users associated with the virtual session are downloaded in parallel by the first device.

10. The method of claim 8, wherein the downloaded avatar information is associated with a base virtual representation of the user of the second device at a first level of quality, the method further comprising:
receiving, from the network device, enhancement information for the virtual representation of the user of the second device; and
generating the second rendering of the virtual representation of the user of the second device at a second level of quality, wherein the second level of quality is greater than the first level of quality.

11. The method of claim 8, further comprising:
receiving, from the network device, a rendering of a virtual representation of a user of a third device; and
rendering the virtual scene including the second rendering of the virtual representation of the user of the second device and the rendering of the virtual representation of the user of the third device.

12. The method of claim 8, wherein the virtual session is initiated as a voice-only session prior to downloading the avatar information for the virtual representation of the user of the second device.

13. The method of claim 8, wherein avatar information for the virtual representation of the user of the second device is encoded to gradually increase a quality of the virtual representation of the user of the second device.

14. The method of claim 8, wherein the avatar information for the virtual representation of the user of the second device is stored locally at the first device for subsequent use during at least one additional virtual session.

15. A non-transitory computer-readable medium of a first device having stored thereon instructions that, when executed by at least one processor, cause the at least one processor to:
begin downloading, from a repository, avatar information for a virtual representation of a user of a second device for a virtual session;
receive, from a network device associated with the virtual session, a first rendering of the virtual representation of the user of the second device while downloading the avatar information for the virtual representation of the user of the second device;
render a virtual scene including the first rendering of the virtual representation of the user of the second device;
upon download of the avatar information for the virtual representation of the user of the second device, generate a second rendering of the virtual representation of the user of the second device using the downloaded avatar information; and
render the virtual scene including the second rendering of the virtual representation of the user of the second device.

16. The non-transitory computer-readable medium of claim 15, wherein the avatar information is rendered at the network device while avatar information for virtual representations of multiple users associated with the virtual session are downloaded in parallel by the first device.

17. The non-transitory computer-readable medium of claim 15, wherein the downloaded avatar information is associated with a base virtual representation of the user of the second device at a first level of quality, and wherein the instructions, when executed by the at least one processor, cause the at least one processor to:
receive, from the network device, enhancement information for the virtual representation of the user of the second device; and
generate the second rendering of the virtual representation of the user of the second device at a second level of quality, wherein the second level of quality is greater than the first level of quality.

18. The non-transitory computer-readable medium of claim 15, wherein the instructions, when executed by the at least one processor, cause the at least one processor to:
receive, from the network device, a rendering of a virtual representation of a user of a third device; and
render the virtual scene including the second rendering of the virtual representation of the user of the second device and the rendering of the virtual representation of the user of the third device.

19. The non-transitory computer-readable medium of claim 15, wherein the virtual session is initiated as a voice-only session prior to downloading the avatar information for the virtual representation of the user of the second device.

20. The non-transitory computer-readable medium of claim 15, wherein avatar information for the virtual representation of the user of the second device is encoded to gradually increase a quality of the virtual representation of the user of the second device, and/or wherein the avatar information for the virtual representation of the user of the second device is stored locally at the first device for subsequent use during at least one additional virtual session.
